(19) United States
(12) Patent Application Publication
(10) Pub. No.: US 2026/0277853 A1
(43) Pub. Date: Sep. 17, 2026

(54) Symbolic Compilation for Reconfigurable Processors

(71) Applicant: SambaNova Systems, Inc., Palo Alto, CA (US)

(72) Inventors: Yaqi ZHANG, Foster City, CA (US); David Alan KOEPLINGER, Egg Harbor, NJ (US); Saubhik Mukherjee, Oshawa (CA); Nathan Zhang, Mountain View, CA (US); Andrew DENG, San Jose, CA (US); Matthew FELDMAN, Palo Alto, CA (US); Jianding LUO, Palo Alto, CA (US); Fei WANG, Palo Alto, CA (US); Angela WANG, Palo Alto, CA (US); Tien-Shuo CHANG, Palo Alto, CA (US); Ayesha SIDDIQUA, San Francisco, CA (US); Weifeng Han, Palo Alto, CA (US); Joshua BROT, Palo Alto, CA (US)

(73) Assignee: SambaNova Systems, Inc., Palo Alto, CA (US)

(21) Appl. No.: 19/566,345

(22) Filed: Mar. 13, 2026

Related U.S. Application Data
(60) Provisional application No. 63/771,588, filed on Mar. 13, 2025.

(51) Int. Cl. G06F 15/78

(52) U.S. Cl. CPC G06F 15/7871; G06F 15/7885

(57) ABSTRACT

A method for compiling a computation graph for execution on a reconfigurable processor comprising one or more configurable compute units. The method may include compiling the computation graph having one or more symbolic dimensions with values unresolved at compile time, where the compiling includes tracking symbolic expressions as functions of the symbolic dimensions. The method may further include producing a compiled configuration for the reconfigurable processor, where the compiled configuration includes one or more configuration parameters derived from the tracked symbolic expressions, the configuration parameters being settable at runtime based on runtime values of the symbolic dimensions.

### PRIORITY APPLICATION

This application claims the benefit of U.S. Provisional Patent Application No. 63/771,588, filed on Mar. 13, 2025, titled, “Dynamic Tensor Shape for a Reconfigurable Processor” (Atty. Docket No. SBNV1215USP01). The provisional application is hereby incorporated by reference for all purposes.

### BACKGROUND

### Technological Field

The present disclosure relates generally to compiler architectures for reconfigurable processors, and more particularly to techniques for compiling computation graphs with symbolic dimensions for execution on reconfigurable processors.

INCORPORATIONS

The following are incorporated by reference for all purposes as if fully set forth herein:

Prabhakar et al., “Plasticine: A Reconfigurable Architecture For Parallel Patterns,” ISCA '17, Jun. 24-28, 2017, Toronto, ON, Canada;

U.S. patent application Ser. No. 16/197,826, filed Nov. 21, 2018, entitled “CONFIGURATION LOAD OF A RECONFIGURABLE DATA PROCESSOR”; and

U.S. patent application Ser. No. 16/198,086, filed Nov. 21, 2018, entitled “CONFIGURATION UNLOAD OF A RECONFIGURABLE DATA PROCESSOR.”

### Description of Related Art

Reconfigurable processors, including coarse-grained reconfigurable architectures (CGRAs) and dataflow processors, may be configured to execute computation graphs comprising operations on tensors. Compilation methods for reconfigurable processors continue to be developed.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a block diagram of an example reconfigurable data processor system, in accordance with example embodiments of the disclosure.

FIG. 2 illustrates a block diagram of an example tiled architecture for a reconfigurable data processor, in accordance with example embodiments of the disclosure.

FIG. 3A illustrates a block diagram of an example tile array and array level network, in accordance with example embodiments of the disclosure.

FIG. 3B illustrates a block diagram of an example switch unit, in accordance with example embodiments of the disclosure.

FIG. 4 illustrates a block diagram of an example pattern compute unit, in accordance with example embodiments of the disclosure.

FIG. 5 illustrates a block diagram of an example pattern memory unit, in accordance with example embodiments of the disclosure.

FIG. 6 illustrates a block diagram of an example compiler stack for a reconfigurable data processor, in accordance with example embodiments of the disclosure.

FIG. 7 illustrates a block diagram of an example compilation pipeline with a companion module for compiling a computation graph having symbolic dimensions, in accordance with example embodiments of the disclosure.

FIG. 8 illustrates a block diagram of an example companion module internal structure, in accordance with example embodiments of the disclosure.

FIG. 9 illustrates a block diagram of an example end-to-end compilation and runtime flow for executing a computation graph with symbolic dimensions, in accordance with example embodiments of the disclosure.

FIG. 10 illustrates a flow diagram of an example canonicalization process for symbolic expressions within a companion module, in accordance with example embodiments of the disclosure.

FIG. 11 illustrates a flow diagram of an example two-tier inequality resolution process for symbolic expressions during compilation, in accordance with example embodiments of the disclosure.

FIG. 12 illustrates a block diagram of an example tiled execution structure with dynamic iteration counts and static tile dimensions, in accordance with example embodiments of the disclosure.

FIG. 13 illustrates a block diagram of an example compiled configuration artifact structure, in accordance with example embodiments of the disclosure.

FIG. 14 illustrates a block diagram of an example intermediate representation transformation showing a computation graph and companion module before and after compilation with symbolic dimensions, in accordance with example embodiments of the disclosure.

FIG. 15 illustrates a block diagram of an example annotation propagation through arithmetic operations in a companion module, in accordance with example embodiments of the disclosure.

FIG. 16 illustrates a block diagram of an example usage type classification and hardware destination mapping for symbolic expressions, in accordance with example embodiments of the disclosure.

FIG. 17 illustrates a block diagram of an example on-chip dynamic buffer arising from a metapipeline discontinuity during tiled execution, in accordance with example embodiments of the disclosure.

FIG. 18 illustrates a flow diagram of an example user API flow for defining symbolic dimensions and executing a computation graph with multiple shape values, in accordance with example embodiments of the disclosure.

### DETAILED DESCRIPTION

In many implementations, the disclosed technology may improve compilation workflows for reconfigurable processors by enabling a single compilation to produce a compiled configuration that supports execution with multiple different tensor shape values at runtime. Rather than requiring a separate compilation for each unique shape value, the disclosed system may compile a computation graph having symbolic dimensions, track symbolic expressions derived from those dimensions throughout the compilation pipeline, and produce a compiled configuration in which shape-dependent configuration parameters are derived from the tracked symbolic expressions and settable at runtime based on runtime values of the symbolic dimensions.

For a given computation graph having one or more symbolic dimensions, the compiler may treat the symbolic dimensions as unresolved values during compilation, tracking symbolic expressions as functions of those dimensions through successive compilation stages. Because the symbolic tracking may be performed once during compilation and captured in the compiled configuration, the per-shape execution workflow may reduce to receiving runtime shape values, computing derived configuration parameter values from the tracked symbolic expressions, and loading the computed values into the configurable compute units of the reconfigurable processor, with no requirement to recompile the computation graph, regenerate the compiled configuration, or reverify the compiled output.

This compilation-once execution model may yield concrete resource savings. Many real-world computation graphs, such as large language models, involve multiple dimensions that may vary across deployments, including batch size, sequence length, and vocabulary size. Conventional compilation systems for reconfigurable processors either perform a full compilation for each unique shape combination, which may take hours per compilation and may produce dozens of compiled configurations requiring independent verification, or bin shapes into buckets and pad inputs to bucket boundaries, which may waste compute and memory resources on the reconfigurable processor. By contrast, the disclosed system may amortize the cost of compilation over a range of shape values: once a computation graph has been compiled with symbolic dimensions and a compiled configuration has been produced, subsequent executions with different shape values within the supported range may reuse the same compiled configuration without recompilation. This may significantly reduce compilation time, compiled configuration storage, and verification overhead required for each shape variant, and may enable runtime shape changes even for shape combinations that were not anticipated at the time of compilation.

The disclosed technology may also improve the precision and granularity of hardware resource utilization by operating at the level of individual configurable compute unit parameters, rather than treating the entire compiled configuration as an indivisible artifact. During compilation, the system may track how each configuration parameter relates to the symbolic dimensions through specific arithmetic operations, identifying the actual symbolic expressions that determine counter maximum values, counter stride values, datapath immediate values, and other configuration fields. At runtime, only the shape-dependent parameters may be updated based on the actual shape values, while the remaining static configuration data may remain unchanged.

Because the configuration parameters may be derived from symbolic expressions tracked during compilation, the compiled configuration may distinguish between parameters that vary with shape and parameters that are independent of shape. In some implementations, the system may further classify derived symbolic values according to usage types that determine the target hardware destinations and register widths, providing type-safe mapping from symbolic expressions to specific tile unit fields. This may provide additional precision beyond approaches that treat all configuration parameters uniformly or that require complete configuration replacement for each shape change.

Modern reconfigurable processors, such as coarse-grained reconfigurable architectures (CGRAs), may be programmed by compiling computation graphs into configuration data that statically determines the allocation of on-chip compute resources, the connections between configurable compute units, and the programming of individual unit fields such as counters and datapath stages. Compilation systems for such processors may need to determine not only which operations to allocate to which compute units, but also how to configure the units' counters, data paths, and memory interfaces based on the shapes of the tensors flowing through the computation graph.

In one approach, the compilation system may perform a complete compilation for each unique combination of tensor shape values. These per-shape compilation workflows may be computationally expensive, with large models requiring hours per compilation when the mapping is distributed across multiple processing sockets. When a customer or deployment environment requires a different shape value for a model parameter such as batch size or sequence length, a new compilation may be required, and the resulting compiled configuration may need to be independently verified before deployment. The combinatorial growth in shape variants across multiple dimensions, such as batch size, sequence length, and vocabulary size, may make exhaustive pre-compilation impractical for production deployment.

In another approach, compilation systems may bin dimension values into buckets and compile for representative bucket values. Inputs whose dimensions fall between bucket boundaries may be padded to the nearest bucket value. These bucketing approaches may waste compute and memory resources on the reconfigurable processor due to the padding overhead, and the number of buckets may still grow combinatorially across multiple dimensions. Both approaches may suffer from scalability and flexibility limitations: per-shape compilation systems may not scale to the number of shape combinations required in production, and bucketing approaches may not provide efficient utilization for shapes that do not align with bucket boundaries.

Furthermore, the compilation decisions for a reconfigurable processor may be dependent on tensor shape at a fine-grained level. Different shape values may result in different partitioning of the computation graph into execution phases, different allocation of compute units and scratchpad memories, different tiling decisions, and different counter and datapath configurations within individual compute units. When a compilation system generates a compiled configuration for one shape value, the resource allocation and unit programming encoded in that configuration may not be valid for a different shape value. Shape-dependent allocation may be a characteristic of reconfigurable processor compilation that differs from conventional processor compilation, where dynamic instruction execution may accommodate shape variation without requiring changes to the compiled program.

The presence of multiple interacting shape-dependent parameters may exacerbate these problems. A single symbolic dimension such as sequence length may affect tiling decisions, metapipeline iteration counts, memory allocation sizes, counter programming across multiple compute units, and address generation logic. Changes to one dimension may propagate through the compilation in ways that affect many configuration parameters simultaneously. As a result, conventional compilation systems may either regenerate the entire compiled configuration for each shape change, even when only a subset of parameters are affected, or may restrict the supported shape values to a pre-determined set.

In short, there may be a need for a computer-implemented compilation technique for reconfigurable processors that, for example, (i) decouples the shape-dependent configuration parameters from the full compilation workflow, (ii) tracks how configuration parameters relate to symbolic shape dimensions through the compilation pipeline, (iii) enables a single compiled configuration to support a range of shape values, and (iv) can be invoked efficiently at runtime to update only the shape-dependent parameters based on actual runtime shape values.

The disclosed technology may address these problems by compiling computation graphs with symbolic dimensions, tracking symbolic expressions derived from those dimensions through the compilation pipeline, and producing compiled configurations in which shape-dependent configuration parameters are derived from the tracked symbolic expressions and settable at runtime.

In one aspect, a computer-implemented method may compile a computation graph having one or more symbolic dimensions, where the symbolic dimensions have values that are unresolved at compile time. The compilation may include tracking symbolic expressions as functions of the one or more symbolic dimensions throughout a multi-stage compilation pipeline. In some implementations, the tracking may include constructing a companion module in a compiler intermediate representation, the companion module being separate from a main computation module representing the computation graph. In some implementations, two or more stages of the compilation pipeline may each insert respective symbolic expressions into the companion module. In other implementations, the symbolic expressions may be tracked using alternative data structures such as annotation tables, side channels, or inline metadata associated with operations in the computation graph. Hybrid approaches are also possible.

The compilation may produce a compiled configuration for the reconfigurable processor. The compiled configuration may include one or more configuration parameters derived from the tracked symbolic expressions, the one or more configuration parameters being settable at runtime based on runtime values of the symbolic dimensions. In some implementations, the compilation may further produce a runtime-executable function configured to compute derived values for the configuration parameters from the runtime values of the symbolic dimensions. In some implementations, the runtime-executable function may be a host function executable on a host processor coupled to the reconfigurable processor. In other implementations, the derived values may be computed by alternative mechanisms such as lookup tables, interpreter-based evaluation, or on-processor computation. Hybrid approaches are also possible.

In some implementations, the symbolic dimensions may be annotated with minimum values, maximum values, and divisibility factors. The compilation may propagate the minimum values, maximum values, and divisibility factors through arithmetic operations on the symbolic expressions to derive corresponding annotations for the tracked symbolic expressions. The propagated annotations may enable the compiler to make resource allocation decisions based on the possible range of values that each symbolic expression may take at runtime. For example, memory resources of the reconfigurable processor may be allocated based on maximum values of the symbolic dimensions, while tiling decisions may be constrained by the divisibility factors.

In some implementations, the tracking may include canonicalizing new symbolic expressions at creation time to produce canonicalized forms. The canonicalization may be performed responsive to insertion of each new expression, rather than as a separate optimization pass. The canonicalization may include constant folding, elimination of duplicate subexpressions, rewriting to a canonical affine form comprising a sum of scaled symbolic terms and a constant offset, and canceling common factors in division operations when a numerator expression is a multiple of a denominator expression. Equivalence of two symbolic expressions may be determined by identity comparison of their respective canonicalized forms.

In some implementations, the compilation may include resolving symbolic inequality queries by performing a bound analysis using value range annotations of the symbolic dimensions. When the bound analysis is insufficient to resolve the query, a constraint solver may be invoked. In some implementations, the constraint solver may be a satisfiability modulo theories (SMT) solver. Results returned by the constraint solver may be cached for reuse in subsequent matching queries.

In some implementations, the compiled configuration may encode a tiled execution of the computation graph. The configuration parameters may include iteration counts for one or more tiled execution loops, and compute operations within the tiled execution loops may operate on data having static dimensions. The symbolic dimensions may be tiled to respective static tile sizes, where a respective static tile size divides the possible runtime values of the corresponding symbolic dimension. In this manner, on-chip compute operations may be performed on fixed-size data tiles while the iteration counts of the enclosing loops may vary based on the runtime shape values.

In some implementations, the configuration parameters may include counter maximum values, counter stride values, or datapath immediate values of configurable compute units of the reconfigurable processor. Memory resources of the reconfigurable processor may be allocated based on maximum values of the symbolic dimensions.

In another aspect, a method for executing a computation graph on a reconfigurable processor may include loading a compiled configuration onto the reconfigurable processor, computing derived values for configuration parameters from runtime values of symbolic dimensions based on symbolic expressions, setting the configuration parameters to the derived values, and executing the computation graph. In some implementations, the computing may include executing a runtime-executable function generated during compilation of the computation graph from the symbolic expressions. The loading, computing, setting, and executing may be repeated with different runtime values for the symbolic dimensions using the same compiled configuration.

The techniques may be implemented in a system comprising at least one processor and a non-transitory computer-readable medium storing instructions that, when executed by the at least one processor, cause the system to perform the compilation as described above.

In some implementations, the compiled configuration may be stored on a non-transitory computer-readable medium and may be distributed separately from the compilation system. The compiled configuration may include configuration data for the configurable compute units and configuration parameters associated with respective symbolic expressions, enabling a receiving system to execute the computation graph with different shape values without access to the original compilation system.

The disclosed technology may provide concrete technical improvements to computer-implemented compilation and execution systems for reconfigurable processors, rather than merely reorganizing abstract compilation information.

Because the symbolic expression tracking may be performed once during compilation and the resulting configuration parameters may be derived from the tracked expressions, the system may respond to runtime shape changes by computing and loading derived parameter values, without recompiling the computation graph and without regenerating the compiled configuration. This may reduce compilation time from hours per shape variant to a single compilation covering a range of variants, and may reduce the number of compiled configurations stored and verified per model from dozens to one or a small number. In production environments where models are deployed with multiple batch size and sequence length options, this may represent a reduction in compilation compute resources by an order of magnitude or more.

By deriving configuration parameters from symbolic expressions that are tracked through the compilation pipeline, the system may avoid the padding overhead associated with bucketing approaches. When a computation graph is executed with a runtime shape value that is smaller than the maximum, only the actual shape may be used for compute and memory operations, rather than padding to a bucket boundary. This may reduce wasted compute cycles and memory bandwidth on the reconfigurable processor, improving utilization efficiency for shape values that do not coincide with pre-selected bucket sizes.

The use of propagated annotations, including minimum values, maximum values, and divisibility factors, may enable the compiler to make resource allocation decisions that are valid across the entire supported range of shape values during a single compilation. This may avoid the compilation failures that may occur when recompiling for specific shape values, where a particular shape may exceed available on-chip resources or may not satisfy tiling constraints. By considering the range of possible values during compilation, the system may produce compiled configurations with higher confidence of correctness across the supported range.

The construction-time canonicalization of symbolic expressions may enable efficient equivalence checking during compilation without requiring a separate optimization pass. This may maintain compilation speed comparable to static shape compilation even when symbolic expressions are tracked, because the canonicalization may be performed incrementally as expressions are created rather than as a batch operation. The two-tier inequality resolution, using bound analysis as a fast path with constraint solver fallback, may similarly maintain compilation speed by reserving expensive solver invocations for queries that cannot be resolved from propagated bounds.

Handling of on-chip dynamic buffers arising from metapipeline discontinuities, through maximum-value allocation with runtime-controlled access patterns, may further reduce the scope of template and compilation changes required to support symbolic shapes. By tiling symbolic dimensions to static tile sizes, the system may limit the impact of symbolic shapes to off-chip load and store operations and loop iteration counts, while on-chip compute templates may continue to operate on fixed-size data tiles. This may reduce the engineering effort and verification burden associated with supporting symbolic shapes across the compilation stack.

The compiled configuration artifact, including the symbolic dimension metadata, the destination map associating parameters with symbolic expressions, and the reference to the runtime-executable function, may enable distribution of compiled configurations that support multiple shapes without requiring the recipient to have access to the compilation system. This may allow deployment pipelines to adjust shapes at runtime based on workload characteristics, such as adapting batch size to available memory or adjusting sequence length to match prompt length, using a single pre-verified compiled configuration. Collectively, these features may improve how conventional reconfigurable processor compilation and execution systems handle shape variation by enabling more efficient, more flexible execution using fewer compilation resources and across a broader range of shape values than may be practical with per-shape compilation or bucketing-only approaches.

In the following non-limiting examples, various implementations of the systems and techniques described herein are discussed to illustrate how symbolic dimension compilation, companion module tracking, and runtime configuration parameter updates may be combined in different environments and workflows. These examples are provided for illustrative purposes and are not intended to limit the scope of the disclosed technology.

In one example environment, an inference service may execute on a host system coupled to a reconfigurable processor comprising an array of configurable compute units. The service may be configured to receive inference requests from multiple clients, where each request specifies a prompt and a desired batch size.

In a particular example, a large language model may be compiled for deployment on the reconfigurable processor. The model may include an embedding layer, a plurality of encoder layers each comprising multi-head attention and feed-forward operations, and a classifier layer. The computation graph for the model may include a batch size dimension and a sequence length dimension that vary across inference requests. Rather than compiling a separate compiled configuration for each combination of batch size and sequence length, the system may compile the computation graph with the batch size and sequence length as symbolic dimensions.

During compilation, the compiler may receive annotations for the symbolic dimensions. The batch size symbolic dimension may be annotated with a minimum value of 1, a maximum value of 8, and a divisibility factor of 1. The sequence length symbolic dimension may be annotated with a minimum value of 2048, a maximum value of 32768, and a divisibility factor of 1024. The compiler may construct a companion module in the compiler intermediate representation and may track symbolic expressions derived from the batch size and sequence length through successive compilation stages. For example, a graph compiler stage may insert a division operation into the companion module to compute a per-shard sequence length dimension, and a template elaboration stage may insert a multiplication operation to compute a counter maximum for the multi-head attention template based on the product of tiling iterations across the batch and sequence length dimensions.

The compiler may tile the sequence length dimension to a static tile size of 64 across the encoder layers, such that compute operations within the tiled execution loops operate on data having static dimensions of 64 along the sequence length axis. The iteration count of the outer tiled loop may be a configuration parameter derived from the tracked symbolic expression representing the sequence length divided by the tile size. The compiler may allocate on-chip scratchpad memory based on the maximum sequence length value of 32768 and may allocate off-chip memory regions based on the maximum batch size of 8.

The compilation may produce a single compiled configuration and a runtime-executable function. The compiled configuration may include configuration parameters for counter maximum values in the address generation units of the configurable compute units, counter stride values in the compute units implementing the attention operations, and iteration counts for the tiled execution loops across the encoder layers. The runtime-executable function may be configured to receive runtime values for the batch size and sequence length and to compute derived values for the configuration parameters by evaluating the symbolic expressions captured in the companion module.

At runtime, the inference service may receive a first request specifying a batch of 4 prompts, each with a sequence length of 4096 tokens. The service may invoke the runtime-executable function with a batch size value of 4 and a sequence length value of 4096. The runtime-executable function may compute derived values for the configuration parameters, such as an iteration count of 64 for the sequence length tiling loop (4096 divided by the tile size of 64) and adjusted counter maximums for the attention templates. The service may load the derived values into the configuration parameters of the reconfigurable processor and may execute the computation graph.

Subsequently, the inference service may receive a second request specifying a single prompt with a sequence length of 16384 tokens. The service may invoke the runtime-executable function with a batch size value of 1 and a sequence length value of 16384. The runtime-executable function may compute new derived values, such as an iteration count of 256 for the sequence length tiling loop. The service may load the new derived values into the configuration parameters using the same compiled configuration that remains loaded on the reconfigurable processor, and may execute the computation graph for the second request without recompilation.

From a technical standpoint, this example may improve reconfigurable processor utilization by eliminating padding waste for requests that do not align with pre-compiled shape values. A conventional deployment of this model might require separate compiled configurations for batch sizes of 1, 2, 4, and 8 and for sequence lengths of 4096, 8192, 16384, and 32768, yielding 16 compiled configurations that may be independently compiled and verified. The disclosed approach may reduce this to a single compiled configuration covering the entire range, reducing compilation compute from approximately 16 compilation runs (each potentially taking hours) to one, reducing storage for compiled configurations by a corresponding factor, and eliminating the verification overhead for multiple configurations. The runtime overhead of invoking the runtime-executable function and loading derived parameter values may be on the order of microseconds, compared to the hours required for recompilation.

In another example implementation, the system may compile and execute a multi-modal language model in which the number of images provided per inference request varies.

In this example, a multi-modal model may accept a text prompt accompanied by zero or more images. The model architecture may include an image encoder that processes each image into a sequence of visual tokens, a cross-attention mechanism that attends over the visual tokens within each encoder layer, and a text decoder. The number of images per request may vary from zero (a text-only query) to a maximum of 16. Without symbolic dimension support, the system might compile a separate configuration for each possible image count, or might pad all requests to the maximum of 16 images, wasting substantial compute when most requests contain few or no images.

The system may compile the computation graph with the number of images as a symbolic dimension. The symbolic dimension may be annotated with a minimum value of 1, a maximum value of 16, and a divisibility factor of 1. During compilation, the compiler may track symbolic expressions derived from the image count through the compilation pipeline. The graph compiler stage may insert arithmetic operations into the companion module to compute the total number of visual tokens as a function of the image count multiplied by the number of tokens per image. The template elaboration stage may insert operations to compute counter maximums for the cross-attention templates based on the total visual token count.

The compiler may tile the image count dimension to a static tile size of 1, such that each iteration of the outer tiled loop processes one image. Compute operations within the image encoder may operate on data having static dimensions corresponding to a single image. The cross-attention mechanism may use a tiled execution loop whose iteration count is derived from the symbolic image count dimension. The compiler may allocate on-chip buffers for the visual token cache based on the maximum of 16 images, and may use configuration parameters settable at runtime to control how many iterations of the visual token processing loop are actually executed.

At runtime, a first request may include a text prompt with 3 accompanying images. The system may invoke the runtime-executable function with an image count of 3, compute derived values for the cross-attention iteration counts and visual token buffer access patterns, load the values, and execute the model. A subsequent request may be a text-only query. The system may invoke the runtime-executable function with an image count of 1 (the minimum), and the cross-attention loop may execute for a single iteration with minimal visual token processing. Both requests may use the same compiled configuration loaded on the reconfigurable processor.

During compilation, the compiler may encounter a symbolic inequality query when determining whether the total visual token sequence length exceeds a threshold that would require a different attention mode. The compiler may first perform a bound analysis using the propagated annotations of the image count dimension (minimum 1, maximum 16) and the static tokens-per-image value. If the bound analysis is sufficient to resolve the query, the compiler may proceed without invoking a constraint solver. If the bounds overlap with the threshold, the compiler may invoke a satisfiability modulo theories solver to determine whether the inequality holds for all possible values of the image count within the annotated range, and may cache the result for reuse in subsequent queries involving the same symbolic expressions.

This example may provide technical benefits by enabling a single compiled configuration to serve the full range of image counts without padding overhead. For requests with zero or few images, the reconfigurable processor may avoid executing unnecessary visual token processing iterations, reducing latency and compute resource consumption. The elimination of per-image-count compiled configurations may simplify the deployment pipeline and may avoid the combinatorial growth in configurations when the image count dimension is combined with other symbolic dimensions such as batch size or text sequence length.

In another example implementation, the system may support a model development workflow in which an engineer iteratively explores different dimension values during model optimization and performance tuning.

In this example, a machine learning engineer may be developing a new model architecture for deployment on a reconfigurable processor. During development, the engineer may want to evaluate model performance across a range of configuration parameters, including hidden dimension sizes, number of attention heads, and sequence lengths. Conventionally, each change to a dimension value would require a full recompilation, which may take hours for a large model mapped across multiple processing sockets. This compilation latency may significantly slow the development iteration cycle.

The system may allow the engineer to define one or more symbolic dimensions at the application level. In a particular scenario, the engineer may define the sequence length as a symbolic dimension with a minimum value of 512, a maximum value of 8192, and a divisibility factor of 512. The engineer may annotate the input tensor dimensions accordingly and may invoke the compiler to produce a single compiled configuration and associated runtime-executable function.

During compilation, the compiler may construct a companion module and may track symbolic expressions through the graph compiler, template elaboration, kernel compiler, and assembly stages. The canonicalization process may simplify symbolic expressions at creation time. For example, when the template elaboration stage inserts an expression representing the product of two metapipeline iteration counts, the canonical builder may recognize that the expression simplifies to a previously stored expression and may deduplicate the two by identity comparison of their canonicalized forms, avoiding redundant entries in the companion module.

The compiler may produce a compiled configuration in which the tiled execution loops across the encoder layers have symbolic iteration counts derived from the sequence length dimension. The configuration parameters may include counter maximum values and counter stride values in the configurable compute units that implement the attention and feed-forward operations. The compile-time validation may verify that the sequence length dimension satisfies the divisibility constraint for the selected tile size across all operations. The compiler may propagate the minimum, maximum, and divisibility factor annotations through the arithmetic operations in the companion module, and the propagated annotations may confirm that no derived value overflows the register width of any target configurable compute unit across the supported range.

After compilation, the engineer may load the compiled configuration onto the reconfigurable processor and may begin iterating. The engineer may first set the sequence length to 512 and execute the model to measure baseline performance. The engineer may then set the sequence length to 2048 and execute again to observe how performance scales with longer sequences. The engineer may continue adjusting the sequence length in increments of 512 up to 8192, collecting performance data at each value. Each iteration may involve invoking the runtime-executable function with the new sequence length value, loading the computed configuration parameter values into the reconfigurable processor, and executing the model. No recompilation may be required between iterations.

In some implementations, the engineer may additionally define the batch size as a second symbolic dimension, enabling exploration of a two-dimensional space of batch size and sequence length combinations using a single compiled configuration. The companion module may capture symbolic expressions that are functions of both symbolic dimensions, and the runtime-executable function may accept runtime values for both dimensions simultaneously.

From a technical perspective, this example may restructure how model development workflows interact with reconfigurable processor compilation systems. Rather than treating each dimension change as a full recompilation event, the system may amortize the compilation cost across the entire exploration space. For an exploration grid of 16 sequence length values and 8 batch size values, a conventional approach might require 128 separate compilations. The disclosed approach may reduce this to a single compilation, transforming the iteration cycle from hours per configuration change to seconds. This may enable the engineer to explore a broader range of configurations within a given development timeline and may reduce the compute resources allocated to compilation during model development.

The foregoing examples illustrate several ways in which symbolic dimension compilation, companion module tracking, runtime-executable functions, and settable configuration parameters may be combined to support variable-shape execution on reconfigurable processors. These examples may be mixed and matched; for example, the same deployment can use symbolic batch size and sequence length dimensions, construction-time canonicalization and two-tier inequality resolution during compilation, tiled execution with dynamic iteration counts, and a compiled configuration artifact with a preface function reference. Together, they may support and enable the full scope of the method and system claims, while also providing concrete technical effects useful to improve the functionality of a computer system. These effects include, but are not limited to: (i) improved compilation efficiency by enabling a single compilation to produce a compiled configuration valid for a range of shape values, (ii) reduced storage and verification overhead by replacing multiple shape-specific compiled configurations with a single compiled configuration, (iii) reduced runtime latency for shape changes by replacing recompilation with runtime-executable function invocation and configuration parameter loading, (iv) improved compute resource utilization by eliminating padding waste associated with bucketing approaches, (v) improved compilation robustness by using propagated annotations to validate resource allocation across the supported range of shape values during a single compilation, and (vi) increased deployment flexibility by enabling runtime shape adaptation without access to the original compilation system. These improvements may enable the disclosed systems and methods to achieve more efficient and flexible execution across a broader range of shape values compared to per-shape compilation or bucketing-only approaches.

It should be understood that any description herein of a method performing an action or function, a system performing an action or function, or an apparatus performing an action or function is not intended to limit the disclosure to any particular statutory class. Descriptions of methods, systems, apparatuses, and computer-readable media are interchangeable, and any feature described in connection with one statutory class provides support for the others. For example, a method step described herein also describes a system or apparatus configured to perform that step, and a computer-readable medium storing instructions that, when executed, cause a processor to perform that step. Similarly, a system or apparatus described as configured to perform an action or function also describes a method comprising that action or function and a computer-readable medium storing instructions to perform that action or function.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetical, or mechanical, between the things that are connected, without any intervening things or devices.

The term configured (to perform a task or tasks) is a broad recitation of structure generally meaning “having circuitry that” performs the task or tasks during operation. As such, the described item may be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. 112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The following terms or acronyms used herein are defined at least in part as follows:

AGCU: address generator (AG) and coalescing unit (CU).

AIR: arithmetic or algebraic intermediate representation.

ALN: array-level network.

Buffer: an intermediate storage of data.

CGRA: coarse-grained reconfigurable architecture. A data processor architecture that includes one or more arrays of configurable units.

Companion module: a module in a compiler intermediate representation that is separate from a main computation module and that captures symbolic expressions derived from symbolic dimensions during compilation.

Compiled configuration: a configuration file (e.g., a PEF) that encodes tile unit programming for a reconfigurable processor, including static configuration data and one or more configuration parameters that may be settable at runtime.

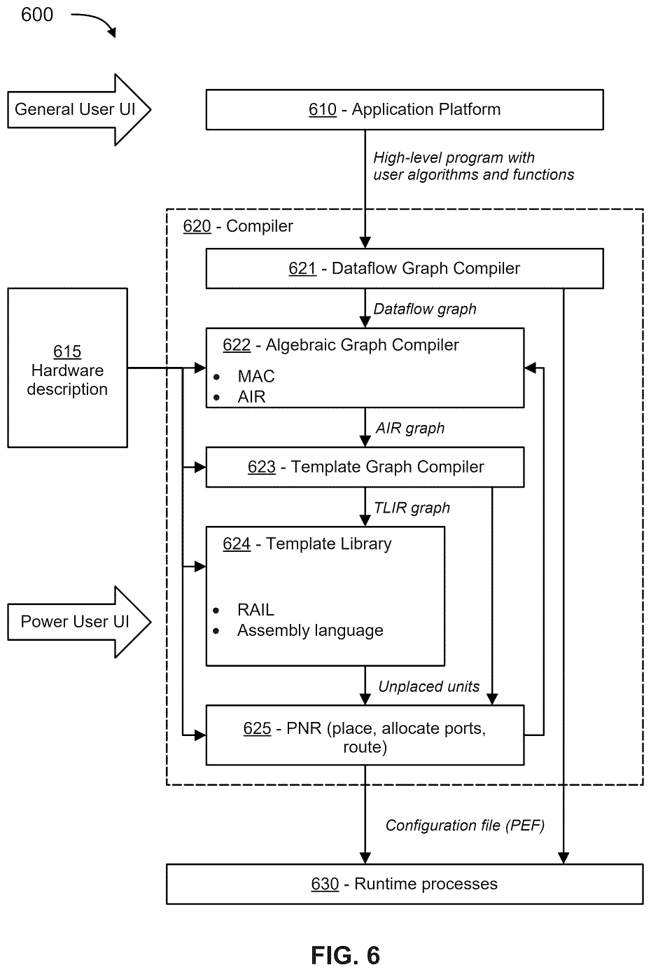

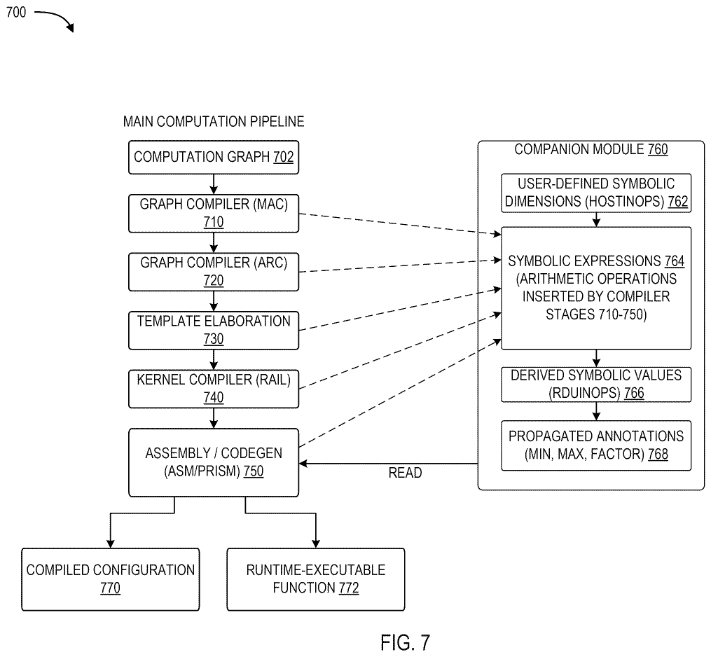

Compiler: a translator that processes statements written in a programming language to machine language instructions or configuration data for a processor. A compiler may include multiple stages to operate in multiple steps. Each stage may create or update an intermediate representation (IR) of the translated statements. Compiler stages are illustrated with reference to FIGS. 6 and 7.

Computation graph: a type of directed graph comprising nodes that represent mathematical operations or expressions and edges that indicate dependencies between the operations or expressions. Edges represent data (e.g., scalars, vectors, tensors) flowing between operations.

Configurable unit: a circuit that may be configured and reconfigured to locally store data (e.g., a memory unit or a PMU), or to execute a programmable function (e.g., a compute unit or a PCU). A configurable unit includes a configuration store and hardwired functionality that performs a limited number of functions. Further examples of configurable units include a CU and an AG, which may be combined in an AGCU.

Configuration parameter: a field in the configuration data store of a configurable unit whose value may be settable at runtime without requiring a full reload of the configuration data store.

CU: coalescing unit.

Datapath: a collection of functional units that perform data processing operations. The functional units may include memory, multiplexers, ALUs, SIMDs, multipliers, registers, buses, etc.

HostInOp: an operation in a companion module representing a user-defined symbolic dimension with associated annotations including minimum value, maximum value, and divisibility factor.

Metapipeline: a subgraph of a computation graph that includes a producer operator providing its output as an input to a consumer operator to form a pipeline.

Metapipelines may be nested within another metapipeline.

PCU: pattern compute unit, a compute unit that may be configured to repetitively perform a sequence of operations.

PEF: processor-executable format, a file format suitable for configuring a configurable data processor.

Pipeline: a staggered flow of operations through a chain of pipeline stages.

PMU: pattern memory unit, a memory unit that can locally store data according to a programmed pattern.

PNR: place and route, the assignment of logical configurable units and associated processing to physical configurable units in an array, and the configuration of communication paths between the physical configurable units.

RAIL: reconfigurable dataflow unit (RDU) abstract intermediate language.

RduInOp: an operation in a companion module representing a compiler-derived symbolic value that may be referenced by a compiled configuration or used in compiler analysis.

Runtime-executable function: a function generated from a companion module during compilation that is configured to receive runtime values for symbolic dimensions and to compute derived values for configuration parameters.

SIMD: single-instruction multiple-data, an arithmetic logic unit (ALU) that simultaneously performs a single programmable operation on multiple data elements delivering multiple output results.

Symbolic dimension: a dimension of a tensor in a computation graph whose value is unresolved at compile time and resolved at runtime.

Symbolic expression: an arithmetic expression that is a function of one or more symbolic dimensions and that is tracked in a companion module during compilation.

TLIR: template library intermediate representation.

TLN: top-level network.

### Example Implementations

The architecture, configurability, and dataflow capabilities of an array of configurable units enable increased compute power that supports both parallel and pipelined computation. A reconfigurable processor, which includes one or more arrays of configurable units, may be programmed to execute dataflow graphs by statically configuring the configurable units. To enable execution, the dataflow graphs may need to be distilled from a high-level program and translated to a configuration file for the reconfigurable processor. A high-level program is source code written in programming languages like Python, C++, and C, and may use computation libraries for scientific computing, machine learning, artificial intelligence, and the like.

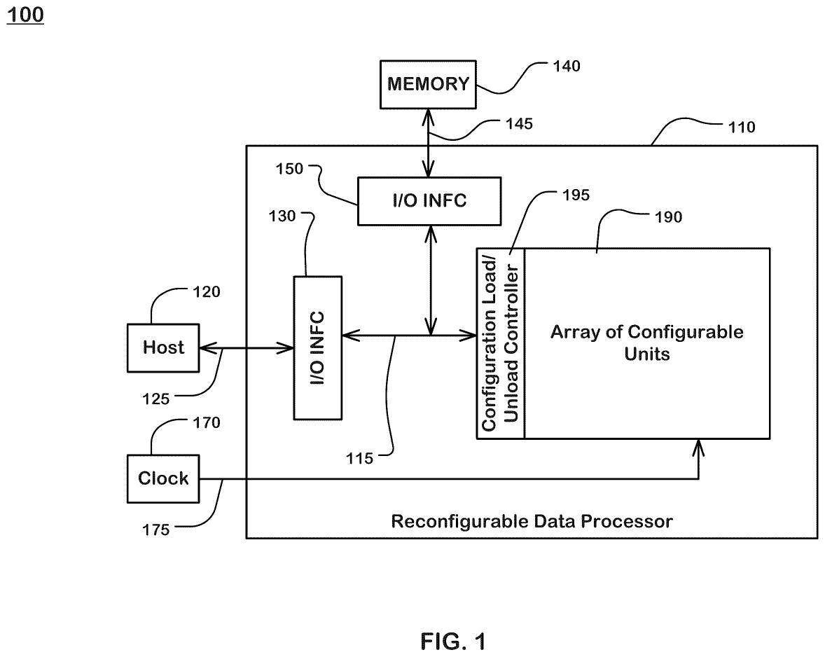

Certain implementations of the disclosure will now be described more fully below with reference to the accompanying figures, in which various aspects are shown. In particular, the following sections describe an example environment, system components, and processing flows in further detail with reference to FIGS. 1 through 18. However, the various aspects may be implemented in many different forms and should not be construed as limited to the implementations set forth herein. The disclosure encompasses many different forms and should not be construed as limited to the implementations set forth herein. It will be appreciated that the disclosure encompasses variations of the implementations, as described herein. Like numbers refer to like elements throughout.

FIG. 1 illustrates a system diagram of an example environment including a reconfigurable data processor 100, in accordance with example embodiments of the disclosure. As illustrated, the environment includes a host 120, a memory 140, and the reconfigurable data processor 100. The reconfigurable data processor 100 may be enclosed within a package or module boundary 110. The reconfigurable data processor 100 includes an array 190 of configurable units, a configuration load/unload controller 195, an external I/O interface 130 connected to the host 120 via a connection 125, and an external I/O interface 150 connected to the memory 140 via a connection 145. The I/O interfaces 130, 150 may connect via a bus system 115 to the array 190 of configurable units and to the configuration load/unload controller 195.

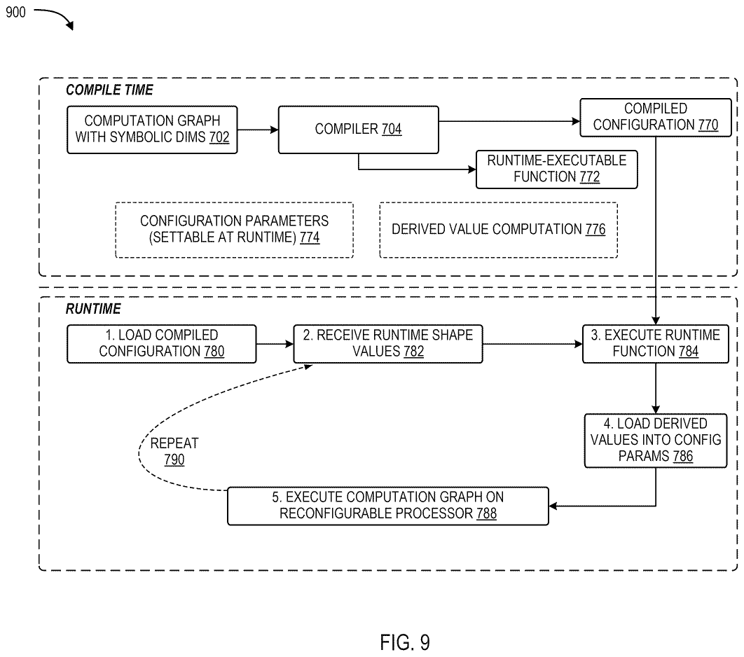

The host 120 may be a host processor that provides configuration data and runtime control to the reconfigurable data processor 100. In some implementations, the host 120 may execute a runtime-executable function that computes derived values for configuration parameters of the reconfigurable data processor 100, as discussed below with respect to FIGS. 7 and 9. In other implementations, the runtime-executable function may execute on a co-processor or on a processing element within the reconfigurable data processor 100 itself.

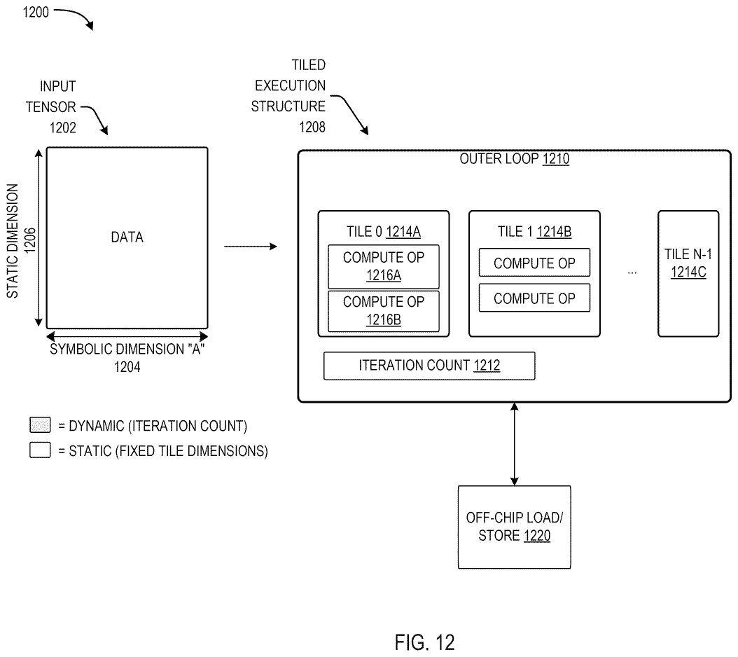

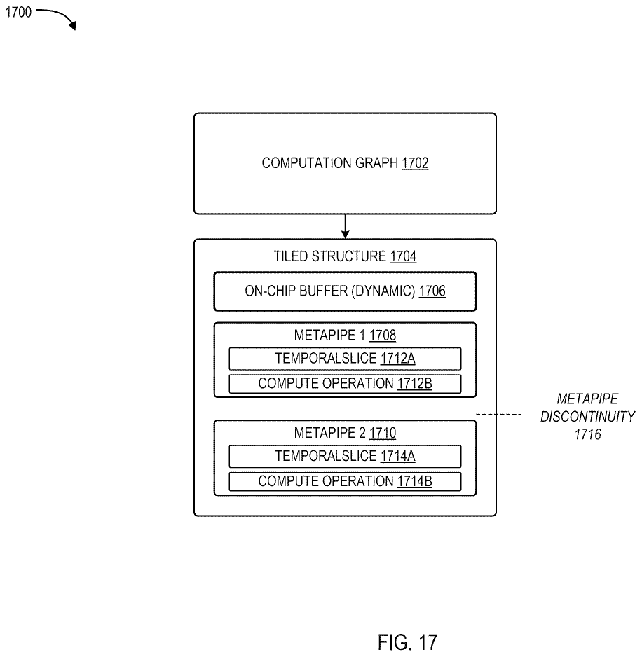

The memory 140 may be an off-chip memory, such as a high-bandwidth memory (HBM) or dynamic random-access memory (DRAM), coupled to the reconfigurable data processor 100 via the I/O interface 150. The memory 140 may store tensors, model weights, intermediate data, and compiled configurations used during execution of a computation graph on the reconfigurable data processor 100. In some implementations, memory resources of the reconfigurable data processor 100 may be allocated based on maximum values of symbolic dimensions, as discussed below with respect to FIGS. 12 and 17.

The bus system 115 may have a bus width configured to carry one chunk of data. In some implementations, a chunk may be 128 bits, although other chunk sizes may be used. In general, a chunk of a configuration file may have a number N of bits of data, and the bus system 115 may be configured to transfer N bits of data in one bus cycle, where N is any practical bus width.

The array 190 of configurable units may include a plurality of configurable compute units that are statically configured at compile time. The configuration of the configurable compute units, including the allocation of compute resources, the connections between units, and the programming of individual unit fields such as counters and datapath stages, may be determined during compilation and encoded in a compiled configuration. The compiled configuration may be loaded onto the reconfigurable data processor 100 via the configuration load/unload controller 195.

To configure the configurable units in the array 190, the host 120 may send a compiled configuration to the memory 140 via the I/O interface 130, the bus system 115, and the I/O interface 150. The compiled configuration may be retrieved from the memory 140 via the memory interface 150. Chunks of the compiled configuration may then be sent in a distribution sequence to the configurable units in the array 190. The compiled configuration may be loaded in various ways as suits a particular architecture, including in data paths outside the reconfigurable data processor 100.

The configuration load/unload controller 195 may load configuration data from the memory 140 into the configurable units of the array 190. The phrase “configuration load/unload controller” as used herein refers to a combination of a configuration load controller and a configuration unload controller. The configuration load controller and the configuration unload controller may be implemented using separate logic and data path resources or may be implemented using shared logic and data path resources as suits a particular embodiment. In some implementations, a system may include only a configuration load controller. In some implementations, a system may include only a configuration unload controller. In some implementations, after an initial configuration load, the reconfigurable data processor 100 may support loading of updated configuration parameter values without requiring a full configuration reload, as discussed below with respect to FIGS. 7 and 9.

An external clock generator 170 or other clock signal source may provide a clock signal 175 to elements in the reconfigurable data processor 100, including the array 190 of configurable units, the bus system 115, and the external data I/O interfaces.

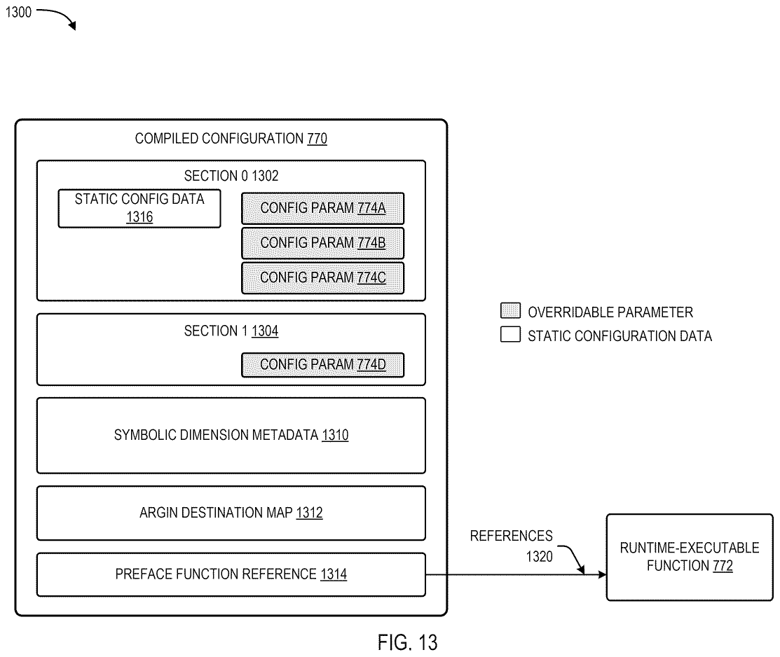

In operation, the host 120 may send a compiled configuration to the memory 140. The configuration load/unload controller 195 may retrieve the compiled configuration from the memory 140 and may distribute configuration data to the configurable units in the array 190. After configuration, the reconfigurable data processor 100 may execute a computation graph by processing data through the configured array 190 of configurable units. In some implementations, after the initial configuration load, the host 120 may update one or more configuration parameters of the configurable units without reloading the entire compiled configuration, enabling execution of the same compiled configuration with different runtime shape values, as discussed below with respect to FIGS. 9 and 13.

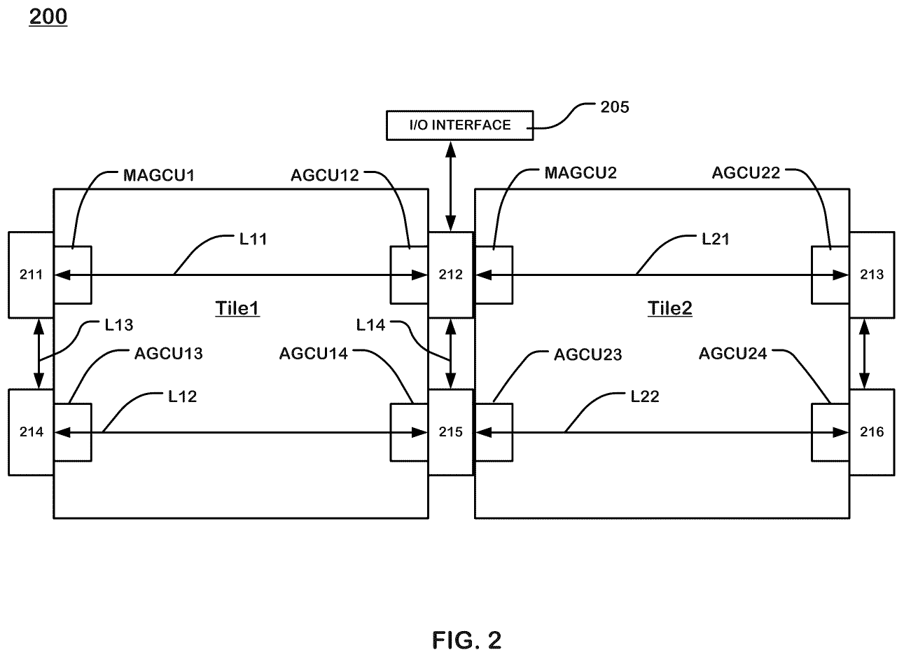

While one reconfigurable data processor is shown, any number of reconfigurable data processors may be used. Although the host 120 is depicted as external to the reconfigurable data processor 100, in some implementations the host processor may be integrated with the reconfigurable data processor. Additional details regarding the configurable units are provided below with respect to FIGS. 2 through 5.

FIG. 2 illustrates a simplified block diagram of components of a reconfigurable data processor 200 having a tiled architecture, in accordance with example embodiments of the disclosure. The reconfigurable data processor 200 may correspond to the reconfigurable data processor 100 described above with reference to FIG. 1. In the illustrated example, the reconfigurable data processor 200 includes two tiles (Tile1, Tile2). Each tile may comprise an array of configurable units connected to a bus system, including an array level network (ALN). The bus system may include a top-level network connecting the tiles to an external I/O interface 205. In other implementations, different numbers of tiles and different bus system configurations may be utilized.

Each tile may include a plurality of Address Generation and Coalescing Units (AGCUs). In the illustrated example, Tile1 includes MAGCU1, AGCU12, AGCU13, and AGCU14, and Tile2 includes MAGCU2, AGCU22, AGCU23, and AGCU24. The AGCUs may be nodes on both the top-level network and the ALN, and may include resources for routing data among nodes on the top-level network and nodes on the ALN within each tile.

One of the AGCUs in each tile may be configured as a master AGCU, which may include a configuration load/unload controller for the tile. In the illustrated example, MAGCU1 includes a configuration load/unload controller for Tile1, and MAGCU2 includes a configuration load/unload controller for Tile2. In other implementations, more than one configuration load/unload controller may be implemented for a single tile. In other implementations, a single configuration load/unload controller may be designed for loading and unloading configuration of more than one tile. Additionally or alternatively, the configuration load/unload controller may be implemented in other portions of the system, including as a stand-alone node on the top-level network and the ALN.

The master AGCU may control operations on the array of configurable units in the tile and may implement a program control state machine to track the state of the tile based on commands received from the host 120. For every state transition, the master AGCU may issue commands to all components on the tile over a daisy-chained command bus. The commands may include a program reset command to reset configurable units and a program load command to load a compiled configuration to the configurable units.

The configuration load controller in the master AGCU may be responsible for reading the compiled configuration from the memory and sending the configuration data to every configurable unit of the tile. The master AGCU may read the compiled configuration from the memory at the maximum throughput of the top-level network. The data read from memory may be transmitted by the master AGCU over a vector interface on the ALN to the corresponding configurable unit according to a distribution sequence.

The top-level network may be constructed using top-level switches (211 through 216) connected to each other and to other nodes on the top-level network, including the AGCUs and the I/O interface 205. The top-level network may include links (e.g., L11, L12, L13, L14, L21, L22) connecting the top-level switches. Data may travel in packets between the top-level switches on the links, and from the switches to the nodes on the network connected to the switches. The links may include one or more buses and supporting control lines, including a chunk-wide bus (vector bus). In some implementations, the top-level network may include data, request, and response channels operable in coordination for transfer of data.

Each AGCU may contain a reconfigurable scalar datapath to generate requests for off-chip memory. Each AGCU may contain FIFOs (first-in-first-out buffers) to buffer outgoing commands, data, and incoming responses from the off-chip memory. The address generators in the AGCUs may generate memory commands that are either dense or sparse. Dense requests may be used to bulk transfer contiguous off-chip memory regions and may be used to read or write chunks of data from or to configurable units in the array. Dense requests may be converted to multiple off-chip memory burst requests by the coalescing unit (CU) in the AGCUs. Sparse requests may enqueue a stream of addresses into the coalescing unit. The coalescing unit may use a coalescing cache to maintain metadata on issued off-chip memory requests and may combine sparse addresses that belong to the same off-chip memory request to minimize the number of issued off-chip memory requests.

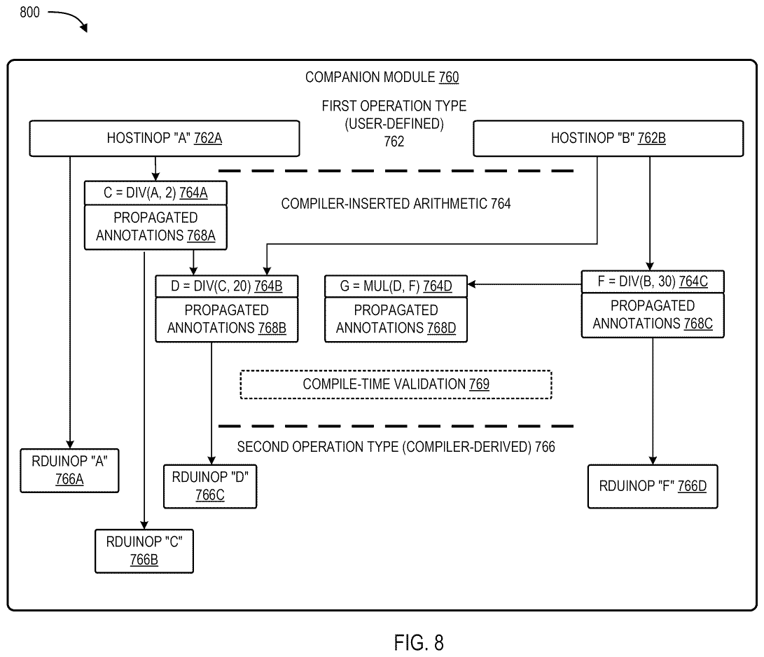

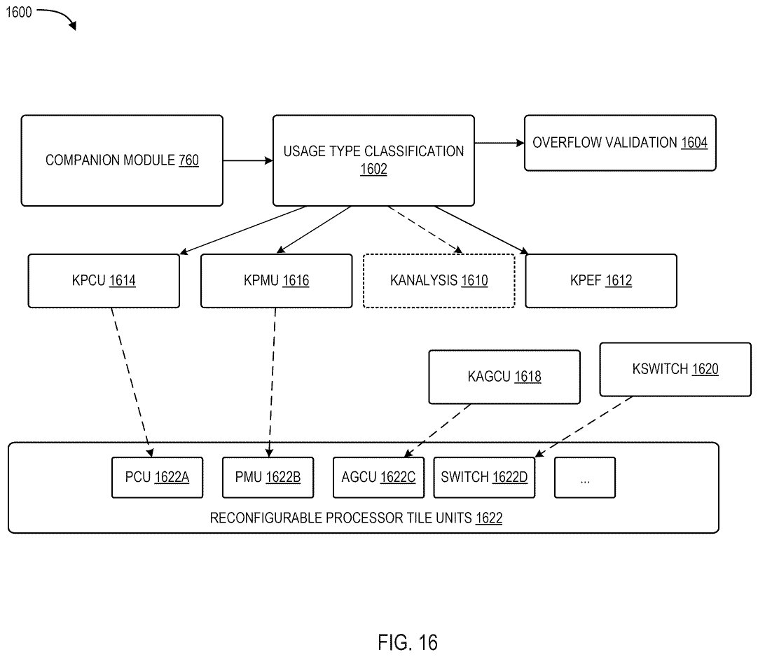

In some implementations, counter maximum values and counter stride values within the AGCUs may be configuration parameters that are settable at runtime based on symbolic dimensions, as discussed below with respect to FIGS. 7 and 16. In some implementations, the address generation logic within the AGCUs may compute off-chip memory addresses as functions of symbolic dimension values, and the corresponding address computation logic may be captured as symbolic expressions in a companion module during compilation, as discussed below with respect to FIG. 8.

While two tiles are shown, any number of tiles may be used. Although four AGCUs per tile are shown, any number of AGCUs may be used per tile. The illustrated configuration is exemplary and other or additional variations may be utilized.

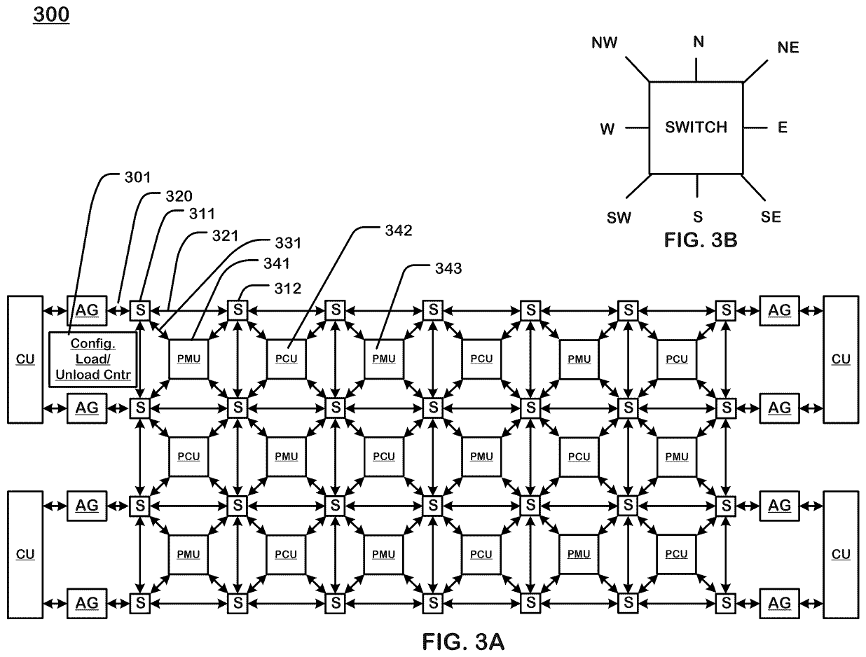

FIGS. 3A and 3B illustrate an example tile array, array level network (ALN), and switch unit configuration usable in the tiled architecture of FIG. 2, in accordance with example embodiments of the disclosure.

More particularly, FIG. 3A illustrates an example array of configurable units 300 within a tile. The array of configurable units 300 may include a plurality of types of configurable units, including Pattern Compute Units (PCUs), Pattern Memory Units (PMUs), switch units(S), and Address Generation and Coalescing Units (each including two address generators AG and a shared CU). Each configurable unit may contain a configuration store comprising a set of registers or flip-flops that represent the setup or the sequence to run a program. The configuration store may include values such as the number of nested loops, the limits of each loop iterator, the instructions to be executed for each stage, the source of the operands, and network parameters for input and output interfaces. Additionally, each configurable unit may contain status registers usable to track progress in nested loops or otherwise.

A configuration file may contain a bit-stream representing the initial configuration, or starting state, of each of the components that execute the program. Program load may be the process of setting up the configuration stores in the array of configurable units based on the contents of the bit-stream to allow all the components to execute a program.

The ALN may include links interconnecting the configurable units in the array. The links in the ALN may include three kinds of physical buses: a chunk-level vector bus (e.g., 128 bits of data), a word-level scalar bus (e.g., 32 bits of data), and a control bus. The three kinds of physical buses may differ in the granularity of data being transferred. In some implementations, the vector bus may carry a chunk that includes 128 bits of data as its payload. The scalar bus may have a 32-bit payload and may carry scalar operands or control information. The control bus may carry control handshakes such as tokens and other signals.

The vector and scalar buses may be packet switched, including headers that indicate a destination of each packet and other information such as sequence numbers. Each packet header may contain a destination identifier that identifies the geographical coordinates of the destination switch unit (e.g., the row and column in the array), and an interface identifier that identifies the interface on the destination switch used to reach the destination configurable unit. The control network may be circuit switched based on timing circuits in the device.

Routing of packets on the vector and scalar networks may be performed using two mechanisms. In some implementations, a dimension order routing mechanism may route packets by traversing a first dimension before traversing a second dimension to the destination. In other implementations, a flow-based routing mechanism may transport packets along routes determined by software-configured flow tables. Flow-based routing may be used to route packets around statically determined congestion points and may be used to provide multicasting from one source to multiple destinations. In some implementations, a switch may select between dimension order routing and flow-based routing based on a field in the packet header.

The vector network may support two flow control classes. A first flow control class may provide end-to-end flow control, where packets are released by a producer only after ascertaining that the consumer has space. A second flow control class may provide local flow control, where packets are released without knowing if the receiver has space. The first flow control class may guarantee forward progress by ensuring that back-pressure from one communication does not prevent forward progress of another communication. In some implementations, a compiler may assign communications to flow control classes based on the data dependencies of the computation graph to prevent deadlock conditions.

A configuration load/unload controller 301 may distribute configuration data to the configurable units via the ALN. The configuration load/unload controller 301 may generate a header for each chunk of configuration data. The header may be transmitted on a header bus to each configurable unit in the array. For a load operation, the configuration load controller may send chunks to a configurable unit in order. For example, for a configurable unit requiring six chunks of configuration data, the chunks may be sent in most-significant-bit-first order.

For instance, a chunk of configuration data for a PMU 341 may be sent from the configuration load/unload controller 301 via a link 320 between the controller 301 and the West vector interface of switch unit 311, through the switch unit 311, and via a link 331 between the Southeast vector interface of switch unit 311 and the PMU 341. During execution after configuration, data may be sent via the same switch units and links to the configurable units using the vector bus.

FIG. 3B illustrates an example switch unit. As shown, a switch unit may have eight interfaces. The North, South, East, and West interfaces may be used for connections between switch units. The Northeast, Southeast, Northwest, and Southwest interfaces may each be used to make connections to PCU or PMU instances. A set of two switch units in each tile quadrant may have connections to an AGCU.

When a packet reaches an input port of a switch, the switch may inspect the packet to determine whether it should be routed using dimension order routing or flow-based routing. If dimension order routing is selected, the destination identifier may be mapped to a unique output port. If flow-based routing is selected, a flow identifier in the packet may be used to index into a table that identifies the output ports to which the packet should be forwarded.

In some implementations, the ALN may extend across all tiles present in the chip. Border switches between neighboring tiles may be configured to allow or disallow communication between those tiles. This may be useful to maintain separation between tiles running distinct programs or to allow communication between tiles running the same program.

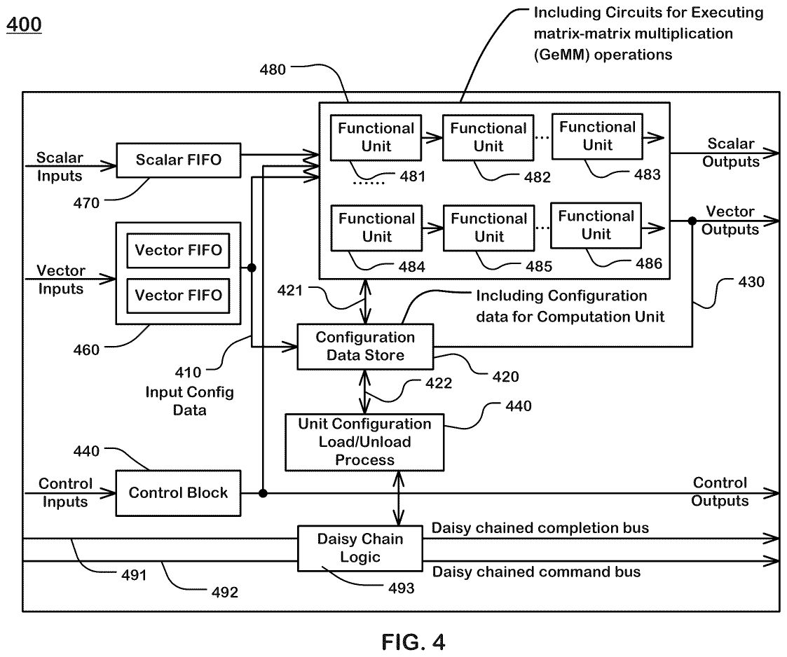

FIG. 4 illustrates a block diagram of an example configurable unit 400, such as a Pattern Compute Unit (PCU), in accordance with example embodiments of the disclosure. The configurable unit 400 may correspond to a configurable compute unit in the array 190 described above with reference to FIG. 1 and the array of configurable units 300 described above with reference to FIG. 3A.

As illustrated, the configurable unit 400 may interface with scalar, vector, and control buses using three corresponding sets of inputs and outputs (410): scalar inputs/outputs, vector inputs/outputs, and control inputs/outputs. Scalar inputs and outputs may be used to communicate single words of data (e.g., 32 bits). Vector inputs and outputs may be used to communicate chunks of data (e.g., 128 bits), including receiving configuration data during a unit configuration load process and transmitting and receiving data during operation after configuration. Control inputs and outputs may be used to communicate signals such as the start or end of execution of a configurable unit. Control inputs may be received by a control block 470, and control outputs may be provided by the control block 470.

Each vector input may be buffered using a vector FIFO in a vector FIFO block 460, which may include one or more vector FIFOs. Each scalar input may be buffered using a scalar FIFO 450. Using input FIFOs may decouple timing between data producers and consumers and may simplify inter-configurable-unit control logic by making it robust to input delay mismatches.

The configurable unit 400 may include multiple reconfigurable datapaths in block 480. A datapath may be organized as a multi-stage (Stage 1 through Stage N) reconfigurable SIMD (Single Instruction, Multiple Data) pipeline. The chunks of data pushed into a configuration serial chain in the configurable unit may include configuration data for each stage of each datapath.

A configurable datapath organized as a multi-stage pipeline may include multiple functional units (e.g., 481, 482, 483, 484, 485, 486) at respective stages. In some implementations, a functional unit at the last stage of a multi-stage pipeline may include a configurable module 487 that comprises specialized computational circuits, the combinations of which may be optimized for particular implementations. In some implementations, a configurable unit may include many such specialized computational circuits configured for use in a particular computation graph using configuration data.

The configurable unit 400 may include a configuration data store 420 (e.g., a serial chain) to store a unit file comprising a plurality of chunks of configuration data particular to the configurable unit. The configuration data store 420 may be connected to the datapaths in block 480 via line 421. The configurable unit 400 may include unit configuration load logic 440 connected to the configuration data store 420 via line 422 to execute a unit configuration load process. The unit configuration load process may include receiving, via the vector inputs, chunks of a unit file particular to the configurable unit and loading the received chunks into the configuration data store 420.

In some implementations, the configuration data store 420 may comprise a serial chain of latches, where the latches store bits that control configuration of the resources in the configurable unit. A serial chain may include a shift register chain for configuration data and a second shift register chain for state information and counter values connected in series. When a configurable unit receives, for example, 128 bits of configuration data from the master AGCU in one bus cycle, the configurable unit may shift this data through its serial chain at the rate of one bit per cycle. It may take 128 shifter cycles for a configurable unit to load 128 configuration bits. A configurable unit may require multiple chunks of data to load all its configuration bits.

Input configuration data 410 may be provided to a vector FIFO as vector inputs and then transferred to the configuration data store 420. Output configuration data 430 may be unloaded from the configuration data store 420 using the vector outputs.

The configurable unit 400 may include daisy chain logic 493 connected to a daisy-chained completion bus 491 and a daisy-chained command bus 492. The daisy-chained completion bus may be used to indicate when a load or unload command has been completed. The master AGCU may transmit program load and unload commands to configurable units over the daisy-chained command bus. Other topologies for the command and completion buses are possible.

In some implementations, the functional units in the datapaths may be configured with immediate values that control the behavior of each pipeline stage. These immediate values, as well as counter maximum values and counter stride values that control loop iteration and data flow within the configurable unit, may be fields in the configuration data store 420. In some implementations, these fields may be configuration parameters that are settable at runtime without requiring a full reload of the configuration data store 420. Additional details regarding how these configuration parameters may be derived from symbolic expressions are provided below with respect to FIGS. 7, 8, and 16.

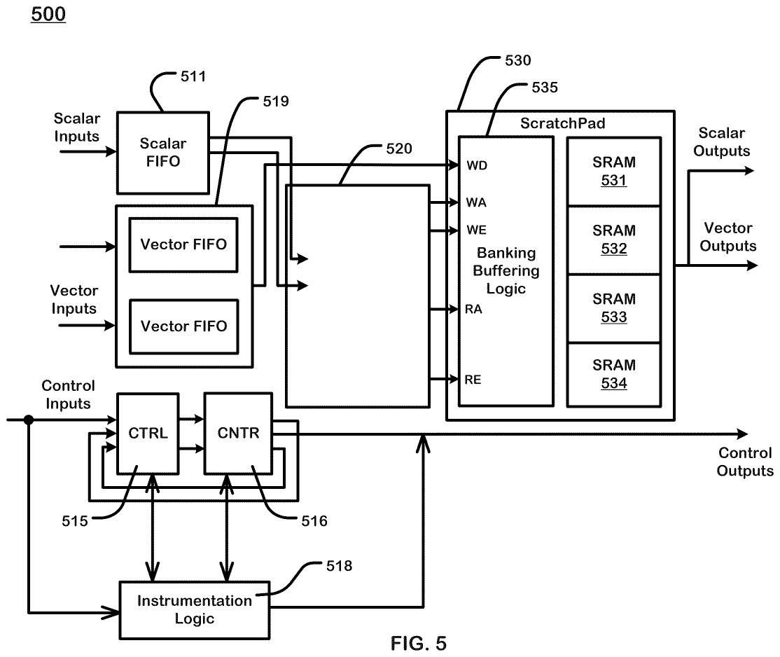

FIG. 5 illustrates a block diagram of an example configurable pattern memory unit (PMU) 500, in accordance with example embodiments of the disclosure. The PMU 500 may correspond to a configurable unit in the array 190 described above with reference to FIG. 1 and the array of configurable units 300 described above with reference to FIG. 3A.

As illustrated, the PMU 500 includes a scratchpad memory 530 coupled with a reconfigurable scalar datapath 520. The scalar datapath 520 may be intended for address calculation (RA, WA) and control (WE, RE) of the scratchpad memory 530, along with bus interfaces used in the PCU described above with reference to FIG. 4. PMUs may be used to distribute on-chip memory throughout the array of configurable units. In some implementations, address calculation within the scratchpad memory 530 may be performed on the PMU scalar datapath 520, while the core computation may be performed within PCUs.

The bus interfaces of the PMU 500 may include scalar inputs, vector inputs, scalar outputs, and vector outputs. The scalar datapath 520 may be organized as a multi-stage reconfigurable pipeline, including stages of functional units and associated pipeline registers that register inputs and outputs of the functional units.

The scratchpad memory 530 may be built with multiple SRAM banks (e.g., 531, 532, 533, 534). Banking and buffering logic 535 may be configured to operate in several banking modes to support various access patterns. In some implementations, the banking modes may include striped banking, interleaved banking, and duplicated banking. The PMU 500 may include write address calculation logic and read address calculation logic that provide write address WA, write enable WE, read address RA, and read enable RE to the banking and buffering logic 535.

A programmable counter chain 516 and control block 515 may trigger PMU execution. Based on the state of local FIFOs 511 and 519 and external control inputs, the control block 515 may be configured to trigger write address computation, read address computation, or both, by enabling the appropriate counters 516.

Instrumentation logic 518 may be included in the PMU 500. The instrumentation logic 518 may be coupled to the control inputs, control outputs, control block 515, and the counter chain 516 for exchanging status signals and control signals.

In some implementations, the scratchpad memory 530 within each PMU may be allocated based on maximum values of symbolic dimensions during compilation, such that the scratchpad capacity may accommodate the largest possible tensor shape within the supported range. At runtime, the actual access pattern into the scratchpad memory 530 may be controlled by counter programming that is derived from runtime values of the symbolic dimensions. For example, a counter maximum value in the counter chain 516 may be a configuration parameter settable at runtime, controlling how many entries of the scratchpad memory 530 are accessed in a given execution. In some implementations, the PMU scalar datapath 520 may compute addresses as functions of runtime shape values using address expressions captured in a companion module during compilation, as discussed below with respect to FIG. 8.

In some implementations, on-chip buffers with dynamic shapes may arise in the scratchpad memory 530 of one or more PMUs when a metapipeline may break along a symbolic dimension, even when that dimension has been tiled. Additional details regarding on-chip dynamic buffers are provided below with respect to FIG. 17.

While one PMU configuration is shown, any number of PMUs may be present in the array, and PMU configurations may vary. The illustrated PMU is exemplary and other or additional variations may be utilized.

FIG. 6 illustrates a block diagram of a compiler stack 600 suitable for generating configuration data for a reconfigurable data processor such as the reconfigurable data processor 100 described above with reference to FIG. 1, in accordance with example embodiments of the disclosure. As illustrated, the compiler stack 600 includes an application platform 610, a hardware description 615, and a compiler 620 having multiple stages including a dataflow graph compiler 621, an algebraic graph compiler 622, a template graph compiler 623, a template library 624, and a placer and router (PNR) 625. The compiler stack 600 may further include runtime processes 630.

The application platform 610 may provide a high-level program (with user algorithms and functions) to the compiler 620 via a general-user interface or a power-user interface. In some implementations, the high-level program may be expressed using deep learning frameworks such as PyTorch or TensorFlow, and may define computation graphs comprising operations on tensors. The hardware description 615 may describe physical resources of the target reconfigurable data processor.

In some implementations, the compiler 620 may produce and transform intermediate representations including a dataflow graph, an algebraic intermediate representation (AIR) graph, and a template-level intermediate representation (TLIR) graph.

The dataflow graph compiler 621 may convert the high-level program into one or more dataflow graphs that may encode data and control dependencies. The dataflow graph compiler 621 may perform graph-level optimizations such as false data dependency elimination, dead-code elimination, constant folding, operator fusion, elimination of redundant computations, and conversion of control-flow constructs into a form suitable for dataflow execution. In some implementations, the dataflow graph compiler 621 may also perform high-level mapping decisions including sharding and tiling based on hardware constraints.

The algebraic graph compiler 622 may translate the dataflow graphs into an algebraic intermediate representation (AIR) and may perform transformations including legalizing graph and mapping decisions, expanding data-parallel and tiling instructions, converting operations to TLIR operations, inserting stage buffers and skip buffers, eliminating redundant operations, and optimizing for resource use, latency, and throughput.

The template graph compiler 623 may translate the mid-level graph provided by the algebraic graph compiler 622 into template-level code optimizing for the target hardware architecture. The template graph compiler 623 may convert intermediate representation operations to appropriate templates, stitch templates together with dataflow and control-flow, and insert necessary buffers and layout transforms. The template library 624 may include reusable templates and low-level interfaces. Templates may be containers for common operations, and may be implemented using assembly language or a higher-level template description language. In some implementations, the template description language may provide a concise, performance-oriented domain-specific language that enables control of interactions between logical compute units and memory units with high-level expressions without the need to manually program capacity splitting, register allocation, and other low-level concerns. The logical compute units and memory units may enable stage and register allocation, context splitting, resource virtualization, and mapping to multiple physical compute units and memory units (i.e., PCUs and PMUs).

The placer and router 625 may map operations represented by the intermediate representations onto configurable units and interconnect resources of the target hardware. The placer and router 625 may perform bandwidth calculations, determine placement of PMUs and PCUs, allocate AGCUs and virtual address generators, perform port selection, control switch configuration, and route data paths. The placer and router 625 may generate a configuration file (PEF) for loading onto the reconfigurable data processor.

In some implementations, an assembler stage may provide an architecture-agnostic low-level programming model and may perform address expression compilation, intra-unit resource allocation and management, legalization with target-specific rules, low-level architecture-specific transformations and optimizations, and architecture-specific code generation.

In some implementations, the configuration file may be provided to runtime processes 630 for execution on the reconfigurable data processor. The runtime processes 630 may load configuration data into the configurable units, may orchestrate execution of kernels corresponding to model operators, and may manage data movement between the memory 140 and the array 190 of configurable units, thereby enabling execution of workloads on the reconfigurable data processor.

Applications may execute on the reconfigurable data processor in a distributed fashion by programming the individual compute and memory components to asynchronously receive, process, and send data and control information. Computation may execute as nested dataflow pipelines that exploit nested parallelism and data locality. These dataflow pipelines may contain several stages of computation, where each stage reads data from one or more input buffers, performs computations on the data while using one or more internal buffers to store and retrieve intermediate results, and produces outputs that are written to one or more output buffers. The structure of these pipelines may depend on the control and dataflow graph representing the application. Pipelines may nest and loop within each other.

In some implementations, the compiler 620 may partition dataflow graphs into memory allocations and execution fragments specified in the configuration file. Execution fragments may represent operations on data. Memory allocations may represent the creation of logical memory spaces in on-chip and off-chip memories for data required to implement the dataflow graphs. The compiler may bind memory allocations to virtual memory units and may bind execution fragments to virtual compute units. In some implementations, the compiler may partition execution fragments into memory fragments and compute fragments. A memory fragment may comprise address calculations leading up to a memory access. A compute fragment may comprise all other operations in the parent execution fragment.

In operation, the compiler 620 may receive a computation graph from the application platform 610 and may process the computation graph through the successive stages 621 through 625 to produce a compiled configuration for the reconfigurable data processor. When the computation graph includes symbolic dimensions, the compiler 620 may additionally construct and maintain a companion module that tracks symbolic expressions through the compilation stages. The companion module may be a separate module in the compiler intermediate representation that lives alongside the main computation module. The symbolic expressions captured in the companion module may be lowered to a runtime-executable function that computes derived configuration parameter values from runtime shape values, as discussed below with respect to FIG. 7. The compiled configuration may include configuration parameters derived from the tracked symbolic expressions and settable at runtime, as discussed below with respect to FIGS. 7 through 9.

While the compiler stages are shown in a particular arrangement, implementations are not limited to this arrangement. In some implementations, additional or different compiler stages may be used, and the stages may operate in a different order or concurrently. Additional details regarding compilation with symbolic dimensions are provided below with respect to FIGS. 7 through 18.

FIG. 7 illustrates a block diagram of an example compilation pipeline 700 for compiling a computation graph having one or more symbolic dimensions for execution on a reconfigurable processor, in accordance with example embodiments of the disclosure. The compilation pipeline 700 may correspond to the compiler 620 described above with reference to FIG. 6. As illustrated, the compilation pipeline 700 includes a computation graph 702, a sequence of compilation stages including a graph compiler (Mac) 710, a graph compiler (Arc) 720, a template elaboration stage 730, a kernel compiler (RAIL) 740, and an assembly/codegen stage (ASM/Prism) 750. The compilation pipeline 700 further includes a companion module 760 that operates in parallel with the compilation stages 710 through 750.

The computation graph 702 may represent a dataflow computation, such as a neural network model, expressed as a graph of operations on tensors. One or more dimensions of the tensors in the computation graph 702 may be symbolic dimensions having values that are unresolved at compile time and resolved at runtime. For example, a batch size dimension or a sequence length dimension of an input tensor may be a symbolic dimension.

The graph compiler (Mac) 710 may receive the computation graph 702 and may perform high-level graph transformations including operation distribution and sharding decisions. The graph compiler (Mac) 710 may propagate symbolic dimensions through the computation graph and may insert symbolic expressions into the companion module 760 representing shape arithmetic derived from the symbolic dimensions.

The graph compiler (Arc) 720 may receive the output of the graph compiler (Mac) 710 and may perform lower-level graph transformations including tiling decisions, loop lowering, and resource allocation. The graph compiler (Arc) 720 may insert additional symbolic expressions into the companion module 760 representing derived values such as metapipe iteration counts and per-shard dimensions.

The template elaboration stage 730 may select and configure templates for individual operations in the computation graph. The template elaboration stage 730 may insert symbolic expressions into the companion module 760 when template programming requires values that are functions of the symbolic dimensions, such as counter maximums derived from enclosing loop iteration counts.

The kernel compiler (RAIL) 740 may generate tile unit programming for the configurable compute units of the reconfigurable processor. The kernel compiler (RAIL) 740 may insert symbolic expressions into the companion module 760 for values used in counter programming, datapath configuration, and address generation that are functions of the symbolic dimensions.

The assembly/codegen stage (ASM/Prism) 750 may read the companion module 760 and may produce two output artifacts: a compiled configuration 770 and a runtime-executable function 772. The compiled configuration 770 may correspond to a configuration file (PEF) as described above with reference to FIG. 6. The compiled configuration 770 may include one or more configuration parameters derived from the symbolic expressions captured in the companion module 760, the one or more configuration parameters being settable at runtime based on runtime values of the symbolic dimensions. The runtime-executable function 772 may be generated from the symbolic expressions in the companion module 760 and may be configured to receive runtime values for the symbolic dimensions and to compute derived values for the configuration parameters. Additional details regarding the compiled configuration 770 are provided below with respect to FIG. 13.

The companion module 760 may be a module in a compiler intermediate representation that is separate from a main computation module representing the computation graph 702. The companion module 760 may include user-defined symbolic dimensions (HostInOps) 762, symbolic expressions 764 representing arithmetic operations inserted by compiler stages 710 through 750, derived symbolic values (RduInOps) 766, and propagated annotations (min, max, factor) 768. Additional details regarding the internal structure of the companion module 760 are provided below with respect to FIG. 8.

In operation, as the compilation pipeline 700 processes the computation graph 702 through successive stages 710 through 750, the stages may insert symbolic expressions into the companion module 760. The companion module 760 may accumulate these expressions throughout the compilation, capturing the complete chain of symbolic arithmetic from user-defined dimensions through compiler-derived values. At the conclusion of compilation, the assembly/codegen stage 750 may read the accumulated symbolic expressions from the companion module 760 and may lower them to the runtime-executable function 772.

While five compilation stages are shown, any number of compilation stages may be used. Although the compilation stages are shown in a sequential arrangement, in some examples, one or more stages may operate concurrently or in a different order.

FIG. 8 illustrates a detailed block diagram 800 of an example companion module 760, in accordance with example embodiments of the disclosure. The companion module 760 may correspond to the companion module 760 described above with reference to FIG. 7.

As illustrated, the companion module 760 includes a first operation type (user-defined) 762 and a second operation type (compiler-derived) 766, with compiler-inserted arithmetic 764 connecting the two. The companion module 760 further includes propagated annotations 768a through 768d associated with the arithmetic operations, and compile-time validation 769.

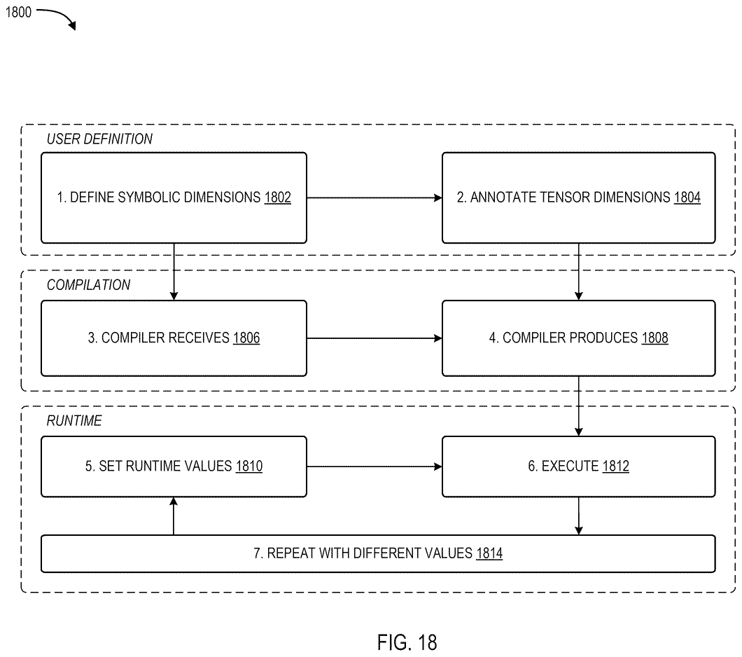

The first operation type 762 may include one or more HostInOps representing user-defined symbolic dimensions. In the illustrated example, the companion module 760 includes a HostInOp “A” 762a and a HostInOp “B” 762b. The HostInOp “A” 762a may be annotated with a minimum value, a maximum value, and a divisibility factor. For example, HostInOp “A” 762a may have a minimum value of 80, a maximum value of 240, and a divisibility factor of 80. The HostInOp “B” 762b may similarly be annotated with a minimum value of 60, a maximum value of 210, and a divisibility factor of 30. These annotations may be provided by a user at the application level to facilitate compiler analysis. Additional details regarding how users define symbolic dimensions and their annotations are provided below with respect to FIG. 18.

The compiler-inserted arithmetic 764 may include one or more arithmetic operations that are functions of the user-defined symbolic dimensions 762. In the illustrated example, the arithmetic operations include a division operation 764a (C=div (A, 2)), a division operation 764b (D=div (C, 20)), a division operation 764c (F=div (B, 30)), and a multiplication operation 764d (G=mul (D, F)). The arithmetic operations 764a through 764d may be inserted by different stages of the compilation pipeline 700 described above with reference to FIG. 7. For example, the graph compiler (Arc) 720 may insert division operation 764a to compute a per-shard dimension, and the template elaboration stage 730 may insert multiplication operation 764d to compute a counter maximum for a template.

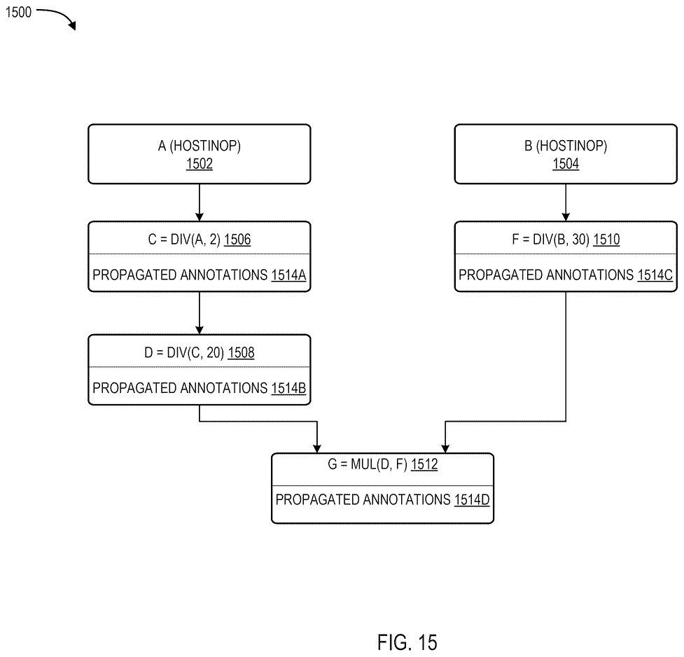

The propagated annotations 768a through 768d may be associated with respective arithmetic operations 764a through 764d. The propagated annotations 768a through 768d may include minimum values, maximum values, and divisibility factors that are derived from the annotations of the HostInOps 762a and 762b by propagating the annotations through the arithmetic operations. For example, if HostInOp “A” 762a has a minimum value of 80 and a divisibility factor of 80, then division operation 764a (C=div (A, 2)) may have propagated annotations 768a indicating a minimum value of 40 and a divisibility factor of 40. Additional details regarding annotation propagation are provided below with respect to FIG. 15.

The compile-time validation 769 may include one or more assertions that are verified during compilation to confirm that the symbolic dimensions satisfy constraints required for valid execution. For example, the compile-time validation 769 may include an assertion that the value of symbolic dimension “A” is evenly divisible by 2 and that the value of symbolic dimension “B” is evenly divisible by 30.

The second operation type 766 may include one or more RduInOps representing compiler-derived symbolic values. In the illustrated example, the companion module 760 includes RduInOp “A” 766a, RduInOp “C” 766b, RduInOp “D” 766c, and RduInOp “F” 766d. The RduInOps 766a through 766d may be referenced by the compiled configuration 770 and may be used in compiler analysis. The RduInOps 766 may be classified according to usage types that determine how the derived values are used during and after compilation. Additional details regarding usage types are provided below with respect to FIG. 16.

In operation, the HostInOps 762 may serve as inputs to the companion module 760, the arithmetic operations 764 may compute derived values as functions of the HostInOps 762, and the RduInOps 766 may capture the derived values for use by the compiled configuration 770 or for compiler analysis. The propagated annotations 768 may enable the compiler to make decisions based on the possible range of values that each symbolic expression may take at runtime.

While two HostInOps and four arithmetic operations are shown, any number of HostInOps, arithmetic operations, and RduInOps may be present. The illustrated example is exemplary and other or additional variations may be utilized.

In some implementations, the compiler may use a symbolic dimension data type to represent tensor dimensions that may be either static or symbolic. The symbolic dimension data type may be similar to a variant type that stores either a static integer value or a string identifier corresponding to a derived symbolic value (RduInOp) in the companion module 760. A symbolic dimensions type may be a container for a list of symbolic dimension values, representing the full shape of a tensor. In some implementations, the symbolic dimensions type may replace static integer shape representations throughout the compiler codebase wherever tensor shapes are passed between compiler logic. This replacement may enable compiler logic to handle both static and symbolic shapes using a uniform interface.

In some implementations, a utility function may be provided to query the shape of a tensor in the compiler intermediate representation. A first version of the utility function may return static integer shapes and may assert if the tensor contains a symbolic dimension. A second version of the utility function may return the symbolic dimensions type, which may include both static and symbolic dimension values. Compiler logic that needs to handle symbolic shapes may use the second version.

In some implementations, the compiler may provide a context object for interacting with the companion module 760. The context object may be accessible from different layers of the compiler stack, including the graph compiler stages 710 and 720, the template elaboration stage 730, the kernel compiler stage 740, and the assembly/codegen stage 750. Each layer may access the context object through a layer-specific accessor. In some implementations, a global pointer to the context object may also be available.

The context object may provide methods for converting symbolic dimension values to host values that can participate in arithmetic operations within the companion module. The host values may be wrapper objects that support operator overloading, enabling compiler logic to express symbolic arithmetic using natural arithmetic syntax (e.g., addition, subtraction, multiplication, division) without confusing which dialect the operation is created in. When a host value is converted back to a symbolic dimension value, an RduInOp may be created in the companion module if one does not already exist for the expression.

In some implementations, the name of the RduInOp may be automatically generated based on the string representation of the expression. For example, an expression representing A divided by 20 may generate an RduInOp with the name “A/20”. In other implementations, an explicit name may be provided for readability, in which case the name may guarantee uniqueness, for example by incorporating a unique identifier of the associated operation.

In some implementations, compiler logic may not create HostInOps for shapes. HostInOps may be defined by application users and may be lowered from the application framework to the graph compiler stage. Compiler logic may create derived expressions using existing HostInOps and RduInOps as inputs.

In some implementations, the companion module 760 may capture symbolic expressions that are not directly related to tensor shapes. For example, lower-level stages of the compiler stack may perform packet count analysis on connections between configurable compute units. The packet count analysis may compute the number of data packets transferred between a producing unit and a consuming unit. For computation graphs with symbolic dimensions, the packet count may also become symbolic because it may be a function of the metapipeline iteration count, which is itself a function of the symbolic dimensions.

The compiler may insert arithmetic operations into the companion module 760 to compute the symbolic packet count. The resulting RduInOp may be defined inside the companion module even though the value is not part of any operation's tensor shape in the main computation module. The propagated annotations (minimum, maximum, and divisibility factor) may be maintained for these non-shape symbolic values, and the compiler may use the annotations for decision-making during compilation.

In some implementations, the companion module 760 may also capture arithmetic on configuration values that are not integers derived from tensor dimensions. For example, a floating-point scale factor may be defined as a HostInOp and used in arithmetic operations within the companion module. The companion module may support multiple data types, including integer types for shape-derived values and floating-point types for non-shape configuration values. The runtime-executable function 772 may compute derived values of different data types based on the data types of the HostInOps and arithmetic operations in the companion module. This generalization may enable the companion module to serve as a unified infrastructure for capturing any compile-time-unknown, runtime-constant configuration value, not limited to tensor shape dimensions.

In some implementations, templates for operations in the computation graph may use shapes from tensor layouts and loop iteration counts in counter and datapath programming of the configurable compute units. When the computation graph has symbolic dimensions, templates may insert arithmetic operations into the companion module 760 to derive counter programming values as functions of the symbolic dimensions.

For example, a template for a particular operation may need to create a counter that counts up to the product of two enclosing metapipeline iteration counts. The template may define a new value in the companion module 760 representing this product, and the resulting RduInOp may be used as a counter maximum value in the corresponding configurable compute unit.

In some implementations, any place in the compiler stack where arithmetic is performed on tensor shape values and the result is used in template or tile unit programming may need to insert the corresponding logic into the companion module 760 rather than computing a static value. This may include address alignment computations, stride calculations, and other derived values used by off-chip load and store templates and on-chip compute templates.

In some implementations, although all tileable symbolic dimensions may be tiled to static tile sizes as described with reference to FIG. 12, certain categories of templates may need to be aware of symbolic shapes.

Off-chip templates, including load templates and store templates, may need to handle dynamic off-chip tensor shapes because the total amount of data to load or store may vary with the runtime value of the symbolic dimensions. In some implementations, load and store templates may be implemented using a kernel-compiler-level description language rather than a lower-level assembly template, and the kernel-compiler-level templates may include support for symbolic addressing and dynamic data transfer sizes.

Some on-chip templates may be aware of the enclosing metapipeline iteration count even though they operate on static tile sizes. For example, an accumulator template may accumulate tensors computed across metapipeline iterations. When the metapipeline iteration count is symbolic, the accumulator template may need a unified mapping that works when the iteration count is one (pass-through mode) and when the iteration count is greater than one (feedback accumulation mode). In some implementations, the accumulator template may be redesigned to handle both modes with the same on-chip resource allocation, enabling the iteration count to be a configuration parameter settable at runtime.

Templates that use random number generation, such as dropout templates, may need to seed the random number generator once per execution phase rather than once per metapipeline iteration. To accomplish this, the template may include a set of counters for all enclosing metapipeline iterations, and these counters may need to take symbolic counter maximum values.

Templates with internal reread counters across metapipeline boundaries, such as linear and layer normalization templates, may need to update the internal reread counter to accept symbolic iteration counts for weight and bias data.

In some implementations, cross-entropy templates that reduce across a batch dimension may need to be updated to accept a symbolic batch dimension value. For example, a parallel cross-entropy template that operates in a mode where the template reduces across the batch dimension may need to use a configuration parameter settable at runtime for the batch reduction count. Reference generation within such templates may also need to handle the batch dimension as a symbolic value rather than a static constant.

In some implementations, a computation graph may include an outer product operation in which two tensors with complementary symbolic dimensions produce an output tensor whose shape is the product of the symbolic dimensions. When such an operation is tiled, the resulting tiled structure may include nested metapipeline loops, both with symbolic iteration counts, and an on-chip buffer with a dynamic shape may appear for one of the operands due to the need to reread the operand across the inner metapipeline boundary.

For example, given a first tensor with shape (A, 1) and a second tensor with shape (1, A), where A is a symbolic dimension, the tiled structure may include an outer metapipeline loop iterating over the first tensor's A dimension and an inner metapipeline loop iterating over the second tensor's A dimension. The second tensor may be loaded into an on-chip buffer with shape (1, A), which has a dynamic dimension. The on-chip buffer may be allocated at the maximum value of A and may be accessed at the actual runtime value using symbolic counter programming. This scenario may be similar to the normalization example discussed below with respect to FIG. 17, but may involve a different discontinuity pattern arising from nested symbolic loops rather than a reduction dependency.

In some implementations, when lowering the computation graph to template-level code at the end of the graph compiler stage, tensor shapes may be captured as tensor layout objects passed through parameters of the templates. The tensor layout objects may capture shape, format, and alignment of tensors and may provide shape-related helper functions. In some implementations, the tensor layout objects may be upgraded to store symbolic dimension types to keep track of symbolic shapes. Shape utility functions may have dynamic versions that take the companion module 760 as an argument and return symbolic dimension types.

FIG. 9 illustrates a block diagram of an example end-to-end flow 900 for compiling and executing a computation graph with symbolic dimensions on a reconfigurable processor, in accordance with example embodiments of the disclosure.

The flow 900 includes a compile-time phase and a runtime phase. During the compile-time phase, a computation graph with symbolic dimensions 702 may be received by a compiler 704. The compiler 704 may correspond to the compilation pipeline 700 described above with reference to FIG. 7. The compiler 704 may track symbolic expressions as functions of the symbolic dimensions throughout compilation and may produce two output artifacts: a compiled configuration 770 and a runtime-executable function 772.

The compiled configuration 770 may include configuration parameters (settable at runtime) 774. The configuration parameters 774 may be derived from the symbolic expressions tracked during compilation and may be associated with respective symbolic expressions in the companion module 760 described above with reference to FIG. 7. Additional details regarding the structure of the compiled configuration 770 are provided below with respect to FIG. 13.

The runtime-executable function 772 may perform derived value computation 776. The derived value computation 776 may include computing, from runtime values of the symbolic dimensions, derived values for the configuration parameters 774 of the compiled configuration 770. The runtime-executable function 772 may be generated from the companion module 760 during the assembly/codegen stage 750 as described above with reference to FIG. 7.

During the runtime phase, the flow 900 may proceed through a sequence of operations. At operation 780, the compiled configuration 770 may be loaded onto the reconfigurable processor. At operation 782, runtime shape values may be received for the symbolic dimensions. For example, a runtime value for a batch size dimension and a runtime value for a sequence length dimension may be received. At operation 784, the runtime-executable function 772 may be executed with the received runtime shape values to compute derived values for the configuration parameters 774. At operation 786, the derived values may be loaded into the configuration parameters of the reconfigurable processor. At operation 788, the computation graph may be executed on the reconfigurable processor using the derived values.

At operation 790, the flow 900 may repeat with different runtime values for the symbolic dimensions. The repeat operation 790 may return to operation 782, where new runtime shape values may be received. The compiled configuration 770 may remain loaded on the reconfigurable processor, and operations 782 through 788 may be repeated with different shape values. In this manner, a single compiled configuration 770 may be used to execute the computation graph with multiple different shape values.

It should be noted that some of the operations of flow 900 may be performed out of the order presented, with additional elements, and/or without some elements. Some of the operations of flow 900 may further take place substantially concurrently and, therefore, may conclude in an order different from the order of operations shown above.

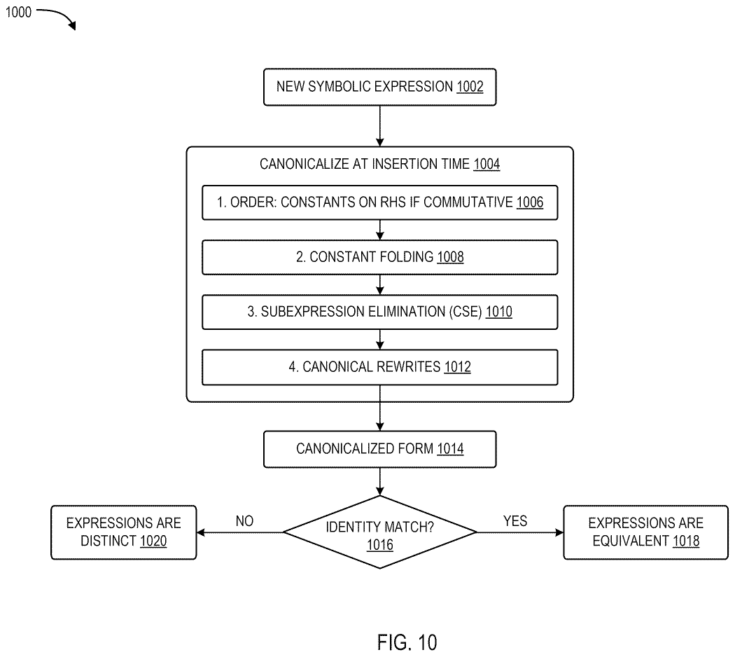

FIG. 10 illustrates a flow diagram of an example canonicalization process 1000 for symbolic expressions within a companion module 760, in accordance with example embodiments of the disclosure. The canonicalization process 1000 may be performed by the compiler 704 during compilation of a computation graph having symbolic dimensions.

A new symbolic expression 1002 may be inserted into the companion module 760 by a stage of the compilation pipeline 700 described above with reference to FIG. 7. Responsive to insertion of the new symbolic expression 1002, the compiler may canonicalize the new symbolic expression at insertion time using a canonicalization process 1004.

The canonicalization process 1004 may include a sequence of transformations applied to the new symbolic expression at the time of its creation. At operation 1006, the canonicalization process 1004 may order constants on the right-hand side of commutative operations. At operation 1008, the canonicalization process 1004 may perform constant folding, replacing sub-expressions composed entirely of constants with their computed values. At operation 1010, the canonicalization process 1004 may perform subexpression elimination (CSE), identifying and deduplicating sub-expressions that are equivalent to previously stored expressions. At operation 1012, the canonicalization process 1004 may apply canonical rewrites, including rewriting expressions to a canonical affine form comprising a sum of scaled symbolic terms and a constant offset, canceling common factors in division operations when a numerator expression is a multiple of a denominator expression, and distributing multiplication over addition.

The result of the canonicalization process 1004 may be a canonicalized form 1014 that is stored in the companion module 760. Because the canonicalization is performed at insertion time rather than as a separate optimization pass, the companion module 760 may maintain all stored expressions in canonicalized form throughout the compilation.

At decision 1016, the compiler may determine whether the canonicalized form 1014 of the new symbolic expression matches a previously stored canonicalized expression by identity comparison. If the canonicalized forms match (yes path), the compiler may determine that the expressions are equivalent 1018. If the canonicalized forms do not match (no path), the compiler may determine that the expressions are distinct 1020.

In operation, the canonicalization process 1000 may enable the compiler to efficiently determine symbolic equality during compilation. For example, an expression A/2+A/2 may be canonicalized to A (when A has a divisibility factor that includes 2), and a separate expression A/4 multiplied by 2 may also be canonicalized to A/2. The compiler may then determine equivalence or distinction by comparing canonicalized forms without invoking a solver.

The canonicalization at insertion time may be particularly suited to the compilation architecture described with reference to FIG. 7, where the companion module 760 is populated by multiple compilation stages interleaved with graph analysis and resource allocation. Because there is no separate build-then-optimize phase for the companion module 760, canonicalization at insertion time may ensure that equivalence checks are available immediately as the compilation proceeds.

It should be noted that some of the operations of process 1000 may be performed out of the order presented, with additional elements, and/or without some elements. Some of the operations of process 1000 may further take place substantially concurrently and, therefore, may conclude in an order different from the order of operations shown above.

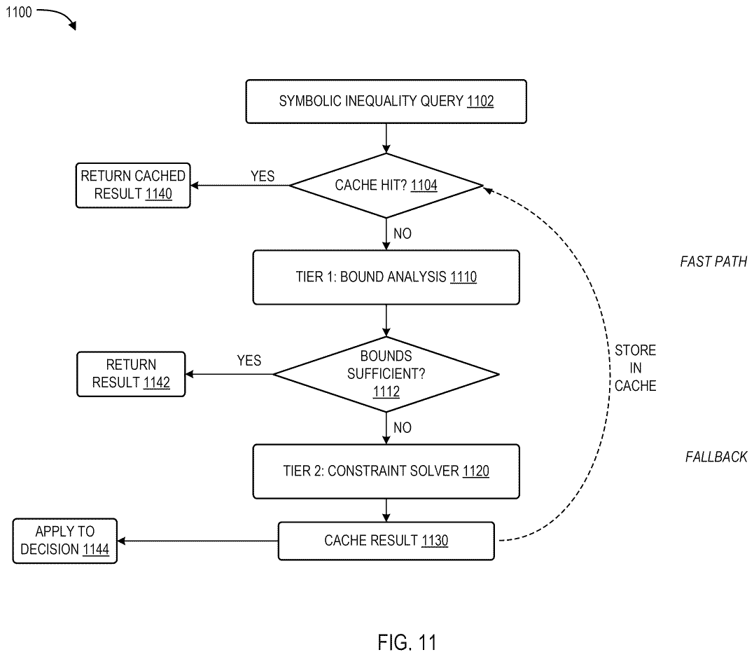

FIG. 11 illustrates a flow diagram of an example inequality resolution process 1100 for resolving symbolic inequality queries during compilation of a computation graph for a reconfigurable processor, in accordance with example embodiments of the disclosure. The inequality resolution process 1100 may be performed by the compiler 704 during compilation when the compiler needs to determine whether a first symbolic expression satisfies an inequality relation with respect to a second symbolic expression.

A symbolic inequality query 1102 may be received by the inequality resolution process 1100. The query 1102 may specify a first symbolic expression, a second symbolic expression, and an inequality relation such as greater than, less than, greater than or equal to, or less than or equal to. The first and second symbolic expressions may be functions of one or more symbolic dimensions of the computation graph.

At decision 1104, the process 1100 may determine whether the query matches a previously cached result. If a cache hit is detected (yes path), the process may return the cached result 1140.

If no cache hit is detected (no path), the process may proceed to a first tier of analysis. At operation 1110, a bound analysis may be performed on the first and second symbolic expressions using propagated value range annotations associated with the symbolic dimensions. The bound analysis 1110 may use the minimum values, maximum values, and divisibility factors propagated through the companion module 760 as described above with reference to FIG. 8 and as discussed below with respect to FIG. 15. The bound analysis 1110 may serve as a fast path for resolving inequality queries.

At decision 1112, the process may determine whether the bounds are sufficient to resolve the inequality. If the bounds are sufficient (yes path), the process may return the result 1142.

If the bounds are not sufficient (no path), the process may proceed to a second tier of analysis. At operation 1120, a constraint solver may be invoked to determine whether the inequality relation holds for all possible values of the symbolic dimensions consistent with the value range annotations. In some examples, the constraint solver may be a satisfiability modulo theories (SMT) solver.

At operation 1130, the result returned by the constraint solver may be cached for reuse in a subsequent matching query. The cached result may be stored in association with the query such that future queries matching the same symbolic expressions and inequality relation may be resolved from the cache at decision 1104 without re-invoking the constraint solver.

At operation 1144, the result of the bound analysis 1110 or the constraint solver 1120 may be applied to a compilation decision for the reconfigurable processor. For example, the result may be used to validate equivalence of input and output element counts for a reshape operation, to legalize a broadcast operation, to verify that a tile size divides a symbolic dimension, or to determine whether a derived value fits within a register width of a configurable compute unit.

In operation, the two-tier architecture of the inequality resolution process 1100 may balance compilation speed with analytical completeness. The bound analysis 1110 may resolve the majority of queries efficiently using propagated annotations, while the constraint solver 1120 may be reserved for queries where the bounds are inconclusive. The cache 1130 may prevent repeated invocations of the constraint solver for equivalent queries arising during compilation.

It should be noted that some of the operations of process 1100 may be performed out of the order presented, with additional elements, and/or without some elements. Some of the operations of process 1100 may further take place substantially concurrently and, therefore, may conclude in an order different from the order of operations shown above.

FIG. 12 illustrates a block diagram of an example tiled execution structure 1200 for executing a computation graph with symbolic dimensions on a reconfigurable processor, in accordance with example embodiments of the disclosure.

As illustrated, an input tensor 1202 may have a symbolic dimension “A” 1204 and a static dimension 1206. The symbolic dimension 1204 may have a value that is unresolved at compile time and resolved at runtime. The static dimension 1206 may have a fixed value determined at compile time.

The input tensor 1202 may be tiled to produce a tiled execution structure 1208. The tiled execution structure 1208 may include an outer loop 1210 with an iteration count 1212 that is a runtime-overridable configuration parameter. The iteration count 1212 may be derived from the symbolic dimension 1204, for example by dividing the runtime value of the symbolic dimension by a static tile size.

Within the outer loop 1210, the tiled execution structure 1208 may include one or more tiles. In the illustrated example, the tiles include tile 0 (1214a), tile 1 (1214b), and tile N−1 (1214c). While three tiles are shown, the number of tiles may vary based on the runtime value of the symbolic dimension 1204 and the tile size.

Within each tile, one or more compute operations may be performed. In the illustrated example, compute operation 1216a and compute operation 1216b are shown within tile 0 (1214a). The compute operations 1216a and 1216b may operate on data having static dimensions equal to respective tile sizes. Because the symbolic dimension 1204 is tiled to a static tile size, the compute operations within the tiles may operate on fixed-size data regardless of the runtime value of the symbolic dimension.

An off-chip load/store 1220 may transfer data between off-chip memory and the tiles. The off-chip load/store 1220 may handle the dynamic off-chip tensor shape associated with the symbolic dimension 1204. In some examples, only load and store templates may need to operate on the dynamic shape, while compute templates within the tiles may operate on static tile dimensions.

In operation, the tiled execution structure 1208 may enable the reconfigurable processor to execute a computation graph with symbolic dimensions by tiling the symbolic dimensions to static tile sizes and varying the iteration count 1212 at runtime. The tile size may be selected such that it divides the possible runtime values of the symbolic dimension, which may be facilitated by the divisibility factor annotation described above with reference to FIG. 8. On-chip configurable compute units may be configured to process tiles of fixed dimensions, while the iteration count of the outer loop may be adjusted at runtime based on the actual value of the symbolic dimension.

While one outer loop is shown, the tiled execution structure 1208 may include nested loops with multiple symbolic iteration counts. The illustrated configuration is exemplary and other or additional variations may be utilized.

In some implementations, the compiler may impose a set of mapping constraints on symbolic dimensions to enable efficient use of on-chip resources. The mapping constraints may include one or more of the following: (i) a symbolic dimension may be tileable on all operations, meaning the dimension is a trivially parallelizable dimension or a reduction dimension with a supported tileable reduction mode; (ii) a symbolic dimension may be tiled, as described above with reference to FIG. 12; (iii) a symbolic dimension may be padded for tiling such that the tile size divides the possible runtime values; (iv) a symbolic dimension may be padded for sharding such that the shard count divides the possible runtime values; (v) in some implementations, a symbolic dimension may be required to have a tile size of one, although this constraint may be relaxed when a sufficiently large divisibility factor is provided; (vi) in some implementations, a symbolic dimension may be required to be the outermost tiled dimension, although this constraint may be relaxed for certain use cases; and (vii) in some implementations, a symbolic dimension may not be sharded unless templates support dynamic split and concatenation operations with symbolic boundaries.

Not all of the foregoing constraints may be required in every implementation. In some implementations, one or more of the constraints may be relaxed based on use cases, available template support, and model requirements. The constraints described herein are exemplary and other or additional constraints may be utilized.

In some implementations, a runtime system may handle memory allocation of logical tensors on device and host memory. To support symbolic dimensions, the runtime system may include capabilities such as the following: (i) a schedule associated with a compiled configuration may understand symbolic dimensions defined in the compiled configuration and may handle associated shape legalization and initialization; (ii) tensor objects may support resizing to accommodate running a single compiled configuration with different shape values across invocations; (iii) the runtime system may support executing the runtime-executable function 772 generated by the compiler to compute derived configuration parameter values; (iv) the runtime system may support symbolic shapes with read-modify-write tensors; and (v) the runtime system may support symbolic shapes across multiple schedules. Other capabilities may also be included.

In some implementations, the runtime-executable function 772 may be executed as a host function on the host 120 described above with reference to FIG. 1. The host function may take a list of user-defined symbolic dimension values as inputs and may compute a list of derived values as outputs. The outputs of the runtime-executable function may be used as dynamic symbol shapes in the compiled configuration or as configuration parameter values in the configurable compute units. In some implementations, the runtime system may allocate memory based on the maximum size specified in the compiled configuration to minimize memory allocation overhead when the runtime-executable function is invoked for each execution.

In some implementations, at the application level, a user may associate symbolic dimension names with specific dimensions of input tensors, as discussed below with respect to FIG. 18. The application framework may trace the computation graph using the maximum shape values of the symbolic dimensions. At runtime, the application framework may retrace the computation graph to associate runtime tensors with the compiled configuration. The user may instantiate the computation graph with input tensors using the same static shape used at compile time and may switch to the actual value of the symbolic dimension when preparing the input data to feed into the reconfigurable processor.

In some implementations, the application framework may not propagate symbolic dimensions across operators during tracing. This means that during tracing, the framework may know that an input tensor has a symbolic dimension, but may not know that intermediate tensors produced by operators also have symbolic dimensions. After compilation, the framework may eventually know the output shape including symbolic dimensions because the output is a user-visible result from the computation graph. This tracing behavior may be a characteristic of the application framework's operation and may not affect the compiler's ability to track symbolic expressions through the companion module 760.

FIG. 13 illustrates a block diagram of an example compiled configuration 770, in accordance with example embodiments of the disclosure. The compiled configuration 770 may correspond to the compiled configuration 770 described above with reference to FIGS. 7 and 9, and may correspond to the configuration file (PEF) described above with reference to FIG. 6.

As illustrated, the compiled configuration 1300 includes one or more sections including section 0 (1302) and section 1 (1304). Each section may encode tile unit programming for a respective execution phase of the computation graph on the reconfigurable processor.

Section 0 (1302) may include static configuration data 1316 and one or more configuration parameters 774a, 774b, and 774c. Section 1 (1304) may include a configuration parameter 774d. The static configuration data 1316 may include tile unit configurations, interconnect programming, and other data that is fixed at compile time. The configuration parameters 774a through 774d may be runtime-overridable and may be associated with respective symbolic expressions derived from symbolic dimensions of the computation graph, as described above with reference to FIG. 8. The configuration parameters 774a through 774d may include values such as counter maximum values, counter stride values, or datapath immediate values for configurable compute units of the reconfigurable processor.

The compiled configuration 770 may further include symbolic dimension metadata 1310. The symbolic dimension metadata 1310 may identify the symbolic dimensions of the computation graph and may include information such as data types and default values for the symbolic dimensions.

The compiled configuration 770 may further include an ArgIn destination map 1312. The ArgIn destination map 1312 may associate configuration parameters 774 with their respective symbolic expressions and may identify the destination tile units in the reconfigurable processor to which the configuration parameters are to be loaded at runtime.

The compiled configuration 770 may further include a preface function reference 1314. The preface function reference 1314 may identify the runtime-executable function 772 that is associated with the compiled configuration 770. The preface function reference 1314 may include a reference 1320 to the runtime-executable function 772. The runtime-executable function 772 may be configured to receive runtime values for the symbolic dimensions and to compute derived values for the configuration parameters 774, as described above with reference to FIG. 9.

In operation, the compiled configuration 770 may be loaded onto the reconfigurable processor. The runtime-executable function 772 may then be invoked with runtime values for the symbolic dimensions. The runtime-executable function 772 may compute derived values for the configuration parameters 774, which may then be loaded into the corresponding tile units identified by the ArgIn destination map 1312. The computation graph may then be executed on the reconfigurable processor using the derived values.

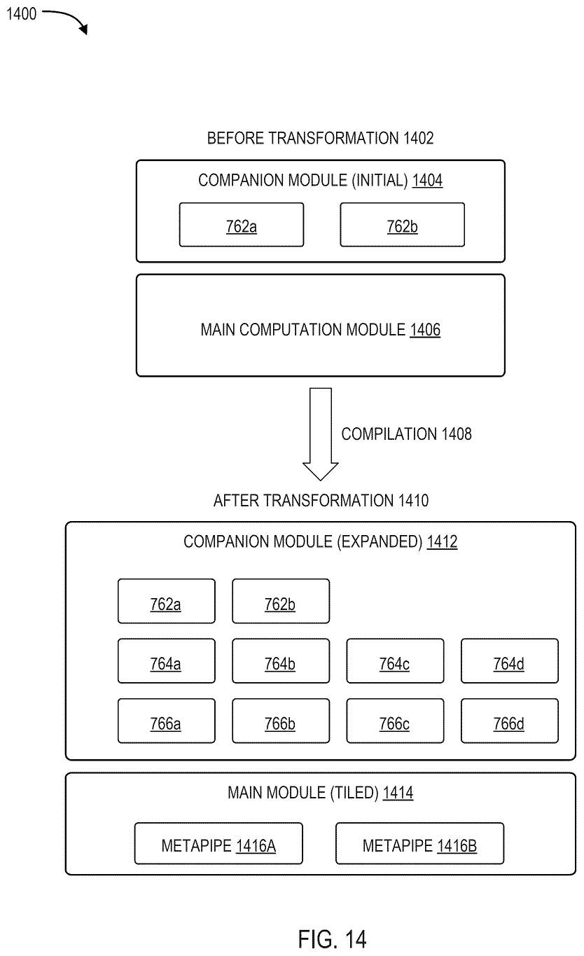

FIG. 14 illustrates a block diagram of an example intermediate representation transformation 1400 showing a computation graph and companion module before and after compilation with symbolic dimensions, in accordance with example embodiments of the disclosure.

As illustrated, the transformation 1400 includes a before-transformation state 1402 and an after-transformation state 1410, connected by a compilation operation 1408.

In the before-transformation state 1402, a companion module (initial) 1404 may include user-defined symbolic dimensions 762a and 762b, corresponding to HostInOps defined at the application level as described above with reference to FIG. 8. A main computation module 1406 may include the computation graph expressed in terms of the symbolic dimensions.

The compilation operation 1408 may apply mapping decisions such as sharding and tiling to the computation graph. During compilation, the compiler may insert derived symbolic expressions into the companion module, as described above with reference to FIG. 7.

In the after-transformation state 1410, a companion module (expanded) 1412 may include the original user-defined symbolic dimensions 762a and 762b, and may further include compiler-inserted arithmetic operations 764a, 764b, 764c, and 764d, and derived symbolic values 766a, 766b, 766c, and 766d. The expanded companion module 1412 may capture the complete chain of symbolic arithmetic from user-defined dimensions through compiler-derived values, as described above with reference to FIG. 8.

A main module (tiled) 1414 may include one or more metapipe structures 1416a and 1416b representing tiled execution loops with symbolic iteration counts derived from the expanded companion module 1412. The compute operations within the metapipe structures 1416a and 1416b may operate on data having static tile dimensions, as described above with reference to FIG. 12.

In operation, the transformation illustrated in FIG. 14 may demonstrate how the companion module 760 grows during compilation as successive compiler stages insert symbolic expressions. The initial companion module 1404 may contain only user-defined symbolic dimensions, while the expanded companion module 1412 may contain the complete set of derived expressions needed to generate the runtime-executable function 772 and the configuration parameters 774 of the compiled configuration 770.

FIG. 15 illustrates a block diagram of an example annotation propagation 1500 through arithmetic operations in a companion module, in accordance with example embodiments of the disclosure. The annotation propagation 1500 may correspond to the propagation of annotations 768 described above with reference to FIG. 8.

As illustrated, the annotation propagation 1500 includes a tree of symbolic expressions rooted at two HostInOps. A HostInOp “A” 1502 may be annotated with a minimum value, a maximum value, and a divisibility factor. A HostInOp “B” 1504 may similarly be annotated with a minimum value, a maximum value, and a divisibility factor.

A division operation 1506 (C=div (A, 2)) may receive the symbolic dimension “A” from HostInOp 1502 as input. Propagated annotations 1514a may be computed for the division operation 1506 based on the annotations of HostInOp 1502 and the divisor. For example, the minimum value of “C” may be computed by dividing the minimum value of “A” by 2, the maximum value of “C” may be computed by dividing the maximum value of “A” by 2, and the divisibility factor of “C” may be computed based on the divisibility factor of “A” and the divisor.

A division operation 1508 (D=div (C, 20)) may receive the output of division operation 1506 as input. Propagated annotations 1514b may be computed for the division operation 1508 based on the propagated annotations 1514a of the preceding operation and the divisor.

A division operation 1510 (F=div (B, 30)) may receive the symbolic dimension “B” from HostInOp 1504 as input. Propagated annotations 1514c may be computed for the division operation 1510 based on the annotations of HostInOp 1504 and the divisor.

A multiplication operation 1512 (G=mul (D, F)) may receive the outputs of division operations 1508 and 1510 as inputs. Propagated annotations 1514d may be computed for the multiplication operation 1512 based on the propagated annotations 1514b and 1514c of the input operations. For example, the minimum value of “G” may be computed by multiplying the minimum values of the inputs, and the divisibility factor of “G” may be computed by multiplying the divisibility factors of the inputs.

In operation, the annotation propagation 1500 may enable the compiler to maintain value range information for all derived symbolic expressions without requiring explicit user annotation of derived values. The propagated annotations may be used by the bound analysis 1110 of the inequality resolution process 1100 described above with reference to FIG. 11, and may be used to validate that derived values fit within register widths of configurable compute units as discussed below with respect to FIG. 16.

Many variations are possible. For example, the propagation rules for other arithmetic operations such as addition, subtraction, modulo, and ceiling division may follow analogous patterns. The illustrated propagation is exemplary and other or additional variations may be utilized.

FIG. 16 illustrates a block diagram of an example usage type classification and hardware destination mapping 1600 for symbolic expressions in a companion module, in accordance with example embodiments of the disclosure. The usage type classification 1600 may determine how derived symbolic values (RduInOps) 766, described above with reference to FIG. 8, are used during and after compilation.

As illustrated, the companion module 760 may provide symbolic expressions to a usage type classification 1602. The usage type classification 1602 may classify each RduInOp into one of a plurality of usage types based on how the derived value is used.

An overflow validation 1604 may verify that the maximum possible value of a derived symbolic expression fits within the register width of its target hardware destination. The overflow validation 1604 may use the propagated maximum value annotations described above with reference to FIG. 15. If the maximum possible value may overflow the target register width, the compiler may report a static error.

The usage types may include a kAnalysis type 1610, a kPef type 1612, a kPCU type 1614, a kPMU type 1616, a kAGCU type 1618, a kSwitch type 1620 and other usage types.

The kAnalysis type 1610 may be used for RduInOps that are used by the compiler for internal analysis during compilation. RduInOps classified as kAnalysis 1610 may be removed by dead code elimination before generation of the compiled configuration 770 and may not be present in the final output.

The kPef type 1612 may be used for RduInOps that represent symbolic dimensions in the compiled configuration 770. RduInOps classified as kPef 1612 may appear as symbol shapes in the compiled configuration and may be used by the runtime to handle dynamic tensor shapes.

The kPCU type 1614 may be used for RduInOps whose derived values are to be loaded into a PCU 1622a of the reconfigurable processor tile units 1622. The kPMU type 1616 may be used for RduInOps whose derived values are to be loaded into a PMU 1622b. The kAGCU type 1618 may be used for RduInOps whose derived values are to be loaded into an AGCU 1622c. The kSwitch type 1620 may be used for RduInOps whose derived values are to be loaded into a switch 1622d. The PCU 1622a may correspond to the configurable compute unit described above with reference to FIG. 4. The PMU 1622b may correspond to the memory unit described above with reference to FIG. 5.

In some examples, the kPCU type 1614 and the kPMU type 1616 may require the derived value to be representable as an unsigned 32-bit integer. The kAGCU type 1618 may require the derived value to be representable as an unsigned 40-bit or 44-bit integer depending on the field. Different usage types may correspond to different register widths, and the overflow validation 1604 may verify compatibility based on the usage type.

In operation, the usage type classification 1602 may enable the compiler to generate appropriate entries in the ArgIn destination map 1312 of the compiled configuration 770 described above with reference to FIG. 13. At runtime, when the runtime-executable function 772 computes derived values for the configuration parameters, the values may be loaded into the specific tile units identified by the usage type classification.

FIG. 17 illustrates a block diagram of an example on-chip dynamic buffer scenario 1700 arising from a metapipe discontinuity during tiled execution, in accordance with example embodiments of the disclosure.

A computation graph 1702 may include operations that require a metapipe discontinuity along a symbolic dimension. For example, a normalization pattern in which a tensor is first summed along a symbolic dimension and the result is then subtracted from the original tensor may require the metapipe to break between the summation and the subtraction because the subtraction depends on the accumulated result of the summation.

When the computation graph 1702 is tiled to produce a tiled structure 1704, the metapipe discontinuity may result in an on-chip buffer (dynamic) 1706. The on-chip buffer 1706 may have a shape that includes the symbolic dimension because the buffer may persist across the metapipe boundary. The on-chip buffer 1706 may be allocated based on the maximum value of the symbolic dimension and may be accessed at runtime based on the actual value of the symbolic dimension using configuration parameters settable at runtime.

The tiled structure 1704 may include a first metapipe 1708 and a second metapipe 1710, separated by a metapipe discontinuity 1716. Within the first metapipe 1708, a temporal slice operation 1712a may read a portion of the on-chip buffer 1706 at each iteration, and a compute operation 1712b may process the sliced data. Within the second metapipe 1710, a temporal slice operation 1714a may read a portion of the on-chip buffer 1706, and a compute operation 1714b may process the sliced data using the accumulated result from the first metapipe 1708.

In operation, the on-chip buffer 1706 may demonstrate that even when all tileable dimensions are tiled to static tile sizes as described above with reference to FIG. 12, a buffer with a dynamic shape may still appear on-chip due to a metapipe discontinuity. The compiler may allocate the on-chip buffer 1706 at the maximum possible size of the symbolic dimension and may use configuration parameters settable at runtime to control the access pattern into the buffer at the actual runtime size.

FIG. 18 illustrates a flow diagram of an example user API flow 1800 for defining symbolic dimensions and executing a computation graph with multiple shape values, in accordance with example embodiments of the disclosure.

The flow 1800 may include a user definition phase, a compilation phase, and a runtime phase.

During the user definition phase, at operation 1802, a user may define one or more symbolic dimensions with associated annotations including minimum values, maximum values, and divisibility factors. For example, a user may define a symbolic dimension for batch size with a minimum value of 1, a maximum value of 8, and a divisibility factor of 1, and may define a symbolic dimension for sequence length with a minimum value of 2048, a maximum value of 32768, and a divisibility factor of 1024.

At operation 1804, the user may annotate one or more tensor dimensions with symbolic dimension names. For example, an input tensor may be traced with a maximum shape, and specific dimensions of the tensor may be associated with the symbolic dimension names defined at operation 1802. Dimensions that are not annotated may remain static.

During the compilation phase, at operation 1806, the compiler may receive the annotated computation graph including the symbolic dimension definitions and annotations. The compiler may create HostInOps 762 in the companion module 760 corresponding to the user-defined symbolic dimensions, as described above with reference to FIGS. 7 and 8.

At operation 1808, the compiler may produce the compiled configuration 770 and the runtime-executable function 772, as described above with reference to FIG. 9.

During the runtime phase, at operation 1810, runtime values may be set for the symbolic dimensions. For example, a batch size value of 4 and a sequence length value of 2048 may be provided.

At operation 1812, the runtime-executable function 772 may be executed with the provided runtime values to compute derived values for the configuration parameters, the derived values may be loaded into the reconfigurable processor, and the computation graph may be executed.

At operation 1814, the flow may repeat with different values for the symbolic dimensions. The flow may return to operation 1810, where new runtime values may be set. The compiled configuration 770 may remain loaded on the reconfigurable processor, and no recompilation may be required. In this manner, a single compilation may support execution with multiple different shape values.

It should be noted that some of the operations of flow 1800 may be performed out of the order presented, with additional elements, and/or without some elements. Some of the operations of flow 1800 may further take place substantially concurrently and, therefore, may conclude in an order different from the order of operations shown above.

In some implementations, the symbolic dimension compilation techniques described herein may be applied to inference workloads. In some implementations, the techniques may additionally be applied to training workloads. Supporting training with symbolic dimensions may involve additional work in application-level tracing and runtime systems. For example, backpropagation during training may require proper dynamic shape tracing in the front-end framework to ensure that gradient computations correctly reflect symbolic dimensions. In some implementations, a runtime system may support training with symbolic dimensions by extending memory management and execution scheduling to accommodate gradient tensors with symbolic shapes. The compiler infrastructure described herein, including the companion module, the canonical builder, and the inequality resolution process, may be shared between inference and training compilation.

In some implementations, split and concatenation operations along symbolic dimensions may be constrained to occur on section boundaries rather than within a section. When a symbolic dimension is split or concatenated on-chip, the split and concatenation boundaries may be symbolic, and supporting symbolic boundaries may require changes to on-chip templates. To avoid this, the compiler may constrain split and concatenation along symbolic dimensions to occur via off-chip load and store operations at section boundaries, where the load and store templates may already support symbolic addressing.

In other implementations, dynamic split and concatenation on-chip may be supported by extending on-chip templates to accept symbolic split and concatenation boundaries. This may require the off-chip load template to compute boundaries based on runtime symbolic dimension values and the on-chip buffer slice view to support symbolic addressing.

In some implementations, a symbolic dimension may be sharded across multiple processing sockets or tiles. When a symbolic dimension is sharded, the data per shard may vary with the runtime value of the symbolic dimension. This may require data rearrangement when the symbolic dimension value changes between invocations if intermediate results with symbolic shape are shared across invocations.

In some implementations, fine-grained interleaving may be used for sharding on symbolic dimensions. Rather than sharding the dimension into contiguous blocks (coarse-grained interleaving), the system may tile the dimension first and then distribute tiles across shards. This may simplify the data layout when the symbolic dimension value changes because each shard may receive a different number of complete tiles rather than a contiguous block of different size.

In some implementations, the compiler may require that symbolic dimensions used for sharding have divisibility factors that are multiples of the shard count, to ensure that the runtime value is always evenly divisible across shards.

In some implementations, a large language model deployed with dynamic sequence length may use a key-value (KV) cache to store intermediate attention results across token generation steps. When the sequence length is a symbolic dimension, the KV cache size may vary with the runtime sequence length value.

In some implementations, the system may use a two-graph approach in which a first compiled configuration covers short sequence lengths (e.g., less than 8192 tokens) with a static KV cache size, and a second compiled configuration covers long sequence lengths (e.g., 8192 tokens and above) with dynamic sequence length. The system may route requests to the appropriate compiled configuration at runtime based on the maximum generation length.

In some implementations, when the sequence length increases during a generation session (e.g., the prompt grows longer than the current KV cache allocation), the system may switch to a compiled configuration with a larger sequence length range. This switch may require resharding the KV cache data across processing tiles if the shard boundaries change with the new sequence length value. The runtime system may update the configuration parameters and initiate a data rearrangement operation before resuming generation with the new compiled configuration.

In some implementations, a mixture-of-experts (MOE) model architecture may include a gating network that routes each token in a sequence to one or more expert sub-networks. The number of tokens assigned to each expert may vary per inference step because it depends on the output of the gating network. This variable token count per expert may not directly correspond to a compile-time symbolic dimension in the sense described herein, because the shape of the expert input tensor may be computed dynamically during execution rather than being provided as a runtime input before execution begins.

In some implementations, the symbolic dimension infrastructure described herein may be adapted to support MOE-like workloads by returning the expert token counts to the host after each gating computation and using them to set configuration parameter values for subsequent sections. This approach may leverage the runtime-executable function and configuration parameter update mechanisms but may introduce runtime overhead from the host round-trip for each encoder layer at each generation step.

In other implementations, a more general dynamic tensor support may be used in which the shape of a tensor is computed on the reconfigurable processor during execution and used subsequently in the same section. This may require load and store templates to accept scalar tensor inputs for computing off-chip loading addresses and may require broadcasting the scalar shape value to all templates enclosed in the metapipeline.

In some implementations, the symbolic dimension compilation techniques described herein may be applied to specific model architectures. For a large language model such as a model with 8 billion parameters, the model may include dimensions for vocabulary size, sequence length, hidden dimension, number of attention heads, head size, and batch size. Different dimensions may have different mapping decisions. For example, the sequence length dimension may be tiled with a tile size of 32 or 64 across encoder layers. The batch size dimension may be tiled with a tile size of 1. The vocabulary size dimension in the classifier may be sharded and tiled. The hidden dimension may be sharded across processing sockets.

When applying symbolic dimensions to such a model, the sequence length and batch size may be designated as symbolic dimensions. The compiler may tile the symbolic sequence length to a static tile size (e.g., 64) and may tile the symbolic batch size to a tile size of 1. The mapping across different components of the model (embedding, encoder attention, encoder feed-forward, classifier) may each have different tiling and sharding configurations, and the companion module 760 may capture the symbolic expressions specific to each component.

In some implementations, a particular mapping for a large language model may organize the encoder into multiple sections. A first section may include query, key, value projections and rotary embeddings with tiling on the sequence length dimension. A second section may include multi-head attention with tensor parallelism on the attention head dimension and tiling on the sequence length dimension. A third section may include the output projection and feed-forward network with tiling on the sequence length dimension.

In some implementations, the graph compiler may perform credit scaling to manage data flow between configurable compute units. Credit scaling may involve dividing counter values to control the rate at which data is produced and consumed across metapipeline stages. When the metapipeline iteration count is symbolic, the credit scaling logic may need to operate on symbolic counter values. In some implementations, the graph compiler stage 720 may insert the credit scaling arithmetic into the companion module 760 and may use derived RduInOps for the scaled counter values.

In some implementations, the configurable compute units of the reconfigurable processor may have certain hardware characteristics that affect symbolic shape support. For example, address generation and coalescing units (AGCUs) may have a limited number of counter stages (e.g., six stages), which may be exhausted for high-dimensional tensors. AGCUs may have a limited number of scalar inputs, which may make it difficult to split address expressions across multiple units. When address computation is split into a PMU, the PMU may have a 32-bit datapath that may overflow for off-chip tensors larger than 4 gigabytes.

In some implementations, list buffers may be used for address generation when the address pattern is a complex function of the symbolic dimension. However, list buffers may consume additional on-chip resources and may be avoided where possible. In some implementations, a separate address generation unit or an extended address pipeline may be used to support more complex address expressions without consuming additional PMU or AGCU resources.

In some implementations, hardware support for making additional fields of the configurable compute units amenable to runtime override (e.g., initialization values, buffer depth modes) may further expand the scope of symbolic dimensions that can be supported with a single compiled configuration.

### Clauses

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections; these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses.
Clause 1. A method for compiling a computation graph for execution on a reconfigurable processor comprising one or more configurable compute units, the method comprising: compiling the computation graph having one or more symbolic dimensions, the one or more symbolic dimensions having values unresolved at compile time, the compiling comprising tracking symbolic expressions as functions of the one or more symbolic dimensions; and producing a compiled configuration for the reconfigurable processor, the compiled configuration comprising one or more configuration parameters derived from the tracked symbolic expressions, the one or more configuration parameters being settable at runtime based on runtime values of the one or more symbolic dimensions.
Clause 2. The method of Clause 1, further comprising generating, from the tracked symbolic expressions, a runtime-executable function configured to compute derived values for the one or more configuration parameters from the runtime values of the one or more symbolic dimensions.
Clause 3. The method of Clause 2, wherein the runtime-executable function is a host function executable on a host processor coupled to the reconfigurable processor.
Clause 4. The method of Clause 1, wherein the tracking comprises constructing a companion module in a compiler intermediate representation, the companion module being separate from a main computation module representing the computation graph.
Clause 5. The method of Clause 4, wherein a first stage and a second stage of a compilation pipeline insert respective symbolic expressions into the companion module.
Clause 6. The method of Clause 1, wherein the one or more symbolic dimensions are annotated with minimum values, maximum values, and divisibility factors.
Clause 7. The method of Clause 6, further comprising propagating the minimum values, the maximum values, and the divisibility factors through arithmetic operations on the symbolic expressions to derive corresponding annotations for the tracked symbolic expressions.
Clause 8. The method of Clause 1, wherein the tracking comprises, responsive to creation of a new symbolic expression, canonicalizing the new symbolic expression at creation time to produce a canonicalized form.
Clause 9. The method of Clause 8, further comprising determining equivalence of two symbolic expressions by identity comparison of their respective canonicalized forms.
Clause 10. The method of Clause 8, wherein the canonicalizing comprises rewriting to a canonical affine form comprising a sum of scaled symbolic terms and a constant offset.
Clause 11. The method of Clause 8, wherein the canonicalizing comprises constant folding.
Clause 12. The method of Clause 8, wherein the canonicalizing comprises elimination of duplicate subexpressions.
Clause 13. The method of Clause 8, wherein the canonicalizing comprises canceling common factors in a division operation when a numerator expression is a multiple of a denominator expression.
Clause 14. The method of Clause 1, further comprising resolving a symbolic inequality query during the compiling by performing a bound analysis using value range annotations of the one or more symbolic dimensions, and responsive to the bound analysis being insufficient to resolve the query, invoking a constraint solver.
Clause 15. The method of Clause 14, further comprising caching a result returned by the constraint solver for reuse in a subsequent matching query.
Clause 16. The method of Clause 14, wherein the constraint solver comprises a satisfiability modulo theories solver.
Clause 17. The method of Clause 1, wherein the compiled configuration encodes a tiled execution of the computation graph, the one or more configuration parameters comprising iteration counts for one or more tiled execution loops, and wherein compute operations within the tiled execution loops operate on data having static dimensions.
Clause 18. The method of Clause 17, wherein the one or more symbolic dimensions are tiled to respective static tile sizes, a respective static tile size dividing the possible runtime values of the corresponding symbolic dimension.
Clause 19. The method of Clause 1, wherein the one or more configuration parameters comprise at least one of a counter maximum value, a counter stride value, or a datapath immediate value of a configurable compute unit.
Clause 20. The method of Clause 1, wherein producing the compiled configuration comprises allocating memory of the reconfigurable processor based on maximum values of the one or more symbolic dimensions.
Clause 21. The method of Clause 1, wherein the one or more symbolic dimensions correspond to at least one of a batch size dimension, a sequence length dimension, or a vocabulary size dimension.
Clause 22. The method of Clause 4, wherein the companion module comprises a first operation type capturing user-defined symbolic dimensions with associated annotations and a second operation type capturing compiler-derived symbolic values referenced by the compiled configuration.
Clause 23. A method for executing a computation graph on a reconfigurable processor comprising one or more configurable compute units, the method comprising: loading a compiled configuration onto the reconfigurable processor, the compiled configuration comprising one or more configuration parameters derived from symbolic expressions that are functions of one or more symbolic dimensions of the computation graph; computing, from runtime values of the one or more symbolic dimensions and based on the symbolic expressions, derived values for the one or more configuration parameters; setting the one or more configuration parameters of the reconfigurable processor to the derived values; and executing the computation graph on the reconfigurable processor.
Clause 24. The method of Clause 23, wherein the computing comprises executing a runtime-executable function generated during compilation of the computation graph from the symbolic expressions.
Clause 25. The method of Clause 23, wherein the loading, computing, setting, and executing are repeated with different runtime values for the one or more symbolic dimensions using the same compiled configuration.
Clause 26. The method of Clause 23, wherein the derived values comprise at least one of a loop iteration count, a memory address offset, or a configuration value for a configurable compute unit.
Clause 27. A system comprising: one or more processors; and a memory storing instructions that, when executed by the one or more processors, cause the system to: compile a computation graph having one or more symbolic dimensions, the one or more symbolic dimensions having values unresolved at compile time, the compiling comprising tracking symbolic expressions as functions of the one or more symbolic dimensions; and produce a compiled configuration for a reconfigurable processor comprising one or more configurable compute units, the compiled configuration comprising one or more configuration parameters derived from the tracked symbolic expressions, the one or more configuration parameters being settable at runtime based on runtime values of the one or more symbolic dimensions.
Clause 28. A non-transitory computer-readable medium storing a compiled configuration for a reconfigurable processor comprising one or more configurable compute units, the compiled configuration comprising: configuration data for the one or more configurable compute units; and one or more configuration parameters associated with respective symbolic expressions, the respective symbolic expressions representing functions of one or more symbolic dimensions of a computation graph from which the compiled configuration was produced, the one or more configuration parameters being settable at runtime based on runtime values of the one or more symbolic dimensions.
Clause 29. The method of Clause 4, further comprising: classifying each derived symbolic value in the companion module according to a usage type corresponding to a target hardware destination of the reconfigurable processor; and validating, based on a propagated maximum value of the derived symbolic value and a register width associated with the usage type, that the propagated maximum value fits within the register width.
Clause 30. The method of Clause 17, wherein the compiling further comprises: identifying an on-chip buffer having a shape that includes a symbolic dimension, the on-chip buffer arising from a metapipeline discontinuity along the symbolic dimension; and allocating the on-chip buffer at a size corresponding to a maximum value of the symbolic dimension, wherein at runtime an access pattern into the on-chip buffer is controlled by at least one of the one or more configuration parameters based on a runtime value of the symbolic dimension.
Clause 31. A method for compiling a computation graph for execution on a reconfigurable processor, the method comprising: compiling the computation graph having a first symbolic dimension and a second symbolic dimension, the first symbolic dimension and the second symbolic dimension each having values unresolved at compile time; tracking, in a companion module, symbolic expressions as functions of the first symbolic dimension and the second symbolic dimension, the symbolic expressions including at least one expression that is a function of both the first symbolic dimension and the second symbolic dimension; and producing a compiled configuration for the reconfigurable processor, the compiled configuration comprising configuration parameters derived from the tracked symbolic expressions.
Clause 32. The method of Clause 31, wherein the first symbolic dimension corresponds to a batch size dimension and the second symbolic dimension corresponds to a sequence length dimension.
Clause 33. A method for compiling a computation graph for execution on a reconfigurable processor comprising one or more configurable compute units, the method comprising: compiling the computation graph having one or more symbolic dimensions; tracking symbolic expressions derived from the one or more symbolic dimensions in a companion module; classifying each of the tracked symbolic expressions according to a usage type, the usage type determining a target hardware destination and a register width for the symbolic expression; and validating, based on a maximum possible value of the symbolic expression and the register width associated with the usage type, that the maximum possible value fits within the register width.
Clause 34. The method of Clause 33, wherein the usage types include at least one of: a first type for compiler-internal analysis, a second type for symbol shapes in the compiled configuration, a third type for pattern compute unit configuration, a fourth type for pattern memory unit configuration, a fifth type for address generation unit configuration, or a sixth type for switch configuration.
Clause 35. The method of Clause 33, further comprising removing, by dead code elimination, symbolic expressions classified as the first type before generation of the compiled configuration.
Clause 36. A method for compiling a computation graph for execution on a reconfigurable processor, the method comprising: compiling the computation graph having one or more symbolic dimensions, the compiling comprising tiling the one or more symbolic dimensions to respective static tile sizes; identifying, during the compiling, an on-chip buffer having a shape that includes a symbolic dimension, the on-chip buffer arising from a metapipeline discontinuity along the symbolic dimension; and allocating the on-chip buffer based on a maximum value of the symbolic dimension, wherein at runtime, an access pattern into the on-chip buffer is controlled by a configuration parameter settable at runtime based on an actual value of the symbolic dimension.
Clause 37. The method of Clause 36, wherein the metapipeline discontinuity arises because a second operation depends on an accumulated result of a first operation computed across iterations of a metapipeline loop along the symbolic dimension.
Clause 38. The method of Clause 36, wherein the metapipeline discontinuity arises from nested metapipeline loops, both having symbolic iteration counts, where an operand of an inner loop is reread across an outer loop boundary.
Clause 39. A method for executing a computation graph on a reconfigurable processor, the method comprising: receiving, at an application level, a definition of one or more symbolic dimensions with associated annotations including minimum values, maximum values, and divisibility factors; annotating one or more tensor dimensions of the computation graph with symbolic dimension names corresponding to the defined symbolic dimensions; compiling the annotated computation graph to produce a compiled configuration and a runtime-executable function; setting runtime values for the one or more symbolic dimensions; executing the runtime-executable function with the runtime values to compute derived values for configuration parameters of the compiled configuration; loading the derived values into the reconfigurable processor; and executing the computation graph on the reconfigurable processor.
Clause 40. The method of Clause 39, further comprising repeating the setting, executing, loading, and executing with different runtime values for the one or more symbolic dimensions using the same compiled configuration, without recompilation.
Clause 41. The method of Clause 39, wherein annotating one or more tensor dimensions comprises tracing the computation graph using maximum shape values of the symbolic dimensions and associating symbolic dimension names with specific dimensions of input tensors.
Clause 42. A method for compiling a computation graph for execution on a reconfigurable processor, the method comprising: compiling the computation graph having one or more symbolic dimensions; tracking, in a companion module, symbolic expressions derived from the one or more symbolic dimensions; and tracking, in the companion module, at least one symbolic expression that is not derived from a tensor dimension of the computation graph, wherein the at least one symbolic expression represents a value used in compiler analysis or in configuration of the reconfigurable processor.
Clause 43. The method of Clause 42, wherein the at least one symbolic expression represents a packet count for a connection between configurable compute units, the packet count being a function of a metapipeline iteration count derived from the one or more symbolic dimensions.
Clause 44. The method of Clause 42, wherein the at least one symbolic expression represents a floating-point configuration value.
Clause 45. The method of Clause 42, wherein the companion module supports multiple data types including integer types for shape-derived values and floating-point types for non-shape configuration values.
Clause 46. A method for compiling a computation graph for execution on a reconfigurable processor, the method comprising: compiling the computation graph having one or more symbolic dimensions, the compiling comprising tracking symbolic expressions in a companion module; wherein a context object for interacting with the companion module is accessible from a plurality of stages of a compilation pipeline, each stage accessing the context object through a respective accessor; and wherein the context object provides methods for converting symbolic dimension values to host values that support operator overloading for arithmetic operations within the companion module.
Clause 47. The method of Clause 46, wherein converting a host value back to a symbolic dimension value causes creation of a derived symbolic value operation in the companion module if one does not already exist for the expression.
Clause 48. The method of Clause 46, wherein a name of the derived symbolic value operation is automatically generated based on a string representation of the expression.
Clause 49. A method for compiling a computation graph for execution on a reconfigurable processor, the method comprising: compiling the computation graph having one or more symbolic dimensions, the compiling comprising: imposing a set of mapping constraints on the one or more symbolic dimensions, the mapping constraints including at least one of: (i) a symbolic dimension is tileable on all operations in the computation graph,
(ii) a symbolic dimension is tiled to a static tile size,
(iii) a tile size divides possible runtime values of the symbolic dimension, or
(iv) a symbolic dimension is not sharded unless templates support dynamic split and concatenation operations with symbolic boundaries; and producing a compiled configuration for the reconfigurable processor based on the mapping constraints.
Clause 50. The method of Clause 49, wherein at least one of the mapping constraints is relaxable based on a divisibility factor annotation of the symbolic dimension.
Clause 51. A method for compiling a computation graph for execution on a reconfigurable processor, the method comprising: compiling the computation graph having one or more symbolic dimensions, the compiling comprising: selecting templates for operations in the computation graph; and for at least one template, inserting arithmetic operations into a companion module to derive counter programming values as functions of the one or more symbolic dimensions, wherein the derived counter programming values are used as configuration parameters settable at runtime for configurable compute units programmed by the template.
Clause 52. The method of Clause 51, wherein the at least one template comprises an accumulator template having a unified mapping that operates in a pass-through mode when a metapipeline iteration count is one and in a feedback accumulation mode when the metapipeline iteration count is greater than one, the metapipeline iteration count being a configuration parameter settable at runtime.
Clause 53. The method of Clause 51, wherein the at least one template comprises a load template or a store template that handles a dynamic off-chip tensor shape by computing data transfer sizes as functions of runtime values of the one or more symbolic dimensions.
Clause 54. A method for compiling a computation graph for execution on a reconfigurable processor, the method comprising: compiling the computation graph having one or more symbolic dimensions; tracking symbolic expressions derived from the one or more symbolic dimensions; capturing tensor shapes as tensor layout objects, the tensor layout objects storing symbolic dimension types that represent both static and symbolic dimension values; and producing a compiled configuration based on the tensor layout objects.
Clause 55. A method for sharding a computation graph having one or more symbolic dimensions across a plurality of processing tiles of a reconfigurable processor, the method comprising: tiling at least one symbolic dimension to a static tile size; distributing tiles across the plurality of processing tiles using fine-grained interleaving, wherein each processing tile receives a respective subset of tiles; and producing a compiled configuration in which a number of tiles per processing tile is a configuration parameter settable at runtime based on a runtime value of the at least one symbolic dimension.
Clause 56. The method of Clause 55, wherein a divisibility factor of the at least one symbolic dimension is a multiple of a number of processing tiles, ensuring the runtime value is evenly divisible across the processing tiles.
Clause 57. A method for deploying a language model on a reconfigurable processor with dynamic sequence length support, the method comprising: compiling the language model with a sequence length as a symbolic dimension to produce a first compiled configuration covering a first range of sequence lengths and a second compiled configuration covering a second range of sequence lengths; routing inference requests to the first compiled configuration or the second compiled configuration based on a maximum generation length of the request; and for each request, setting a runtime value for the sequence length and executing the language model using the selected compiled configuration without recompilation.
Clause 58. The method of Clause 57, further comprising, responsive to a sequence length increasing beyond the first range during a generation session, switching from the first compiled configuration to the second compiled configuration and resharding key-value cache data across processing tiles.
Clause 59. A compiled configuration stored on a non-transitory computer-readable medium for a reconfigurable processor, the compiled configuration comprising: configuration data for one or more configurable compute units; one or more configuration parameters associated with respective symbolic expressions; symbolic dimension metadata identifying symbolic dimensions and associated data types and default values; a destination map associating the configuration parameters with target tile units of the reconfigurable processor; and a reference to a runtime-executable function configured to compute derived values for the configuration parameters from runtime values of the symbolic dimensions.
Clause 60. The compiled configuration of Clause 59, further comprising one or more sections, each section encoding tile unit programming for a respective execution phase of a computation graph, wherein the configuration parameters are distributed across the one or more sections.
Clause 61. A method for compiling a computation graph for execution on a reconfigurable processor, the method comprising: compiling the computation graph having one or more symbolic dimensions; tracking symbolic expressions in a companion module, the companion module comprising: a first set of operations representing user-defined symbolic dimensions with associated annotations; arithmetic operations inserted by a plurality of compilation stages; a second set of operations representing compiler-derived symbolic values; and compile-time assertions verifying that the symbolic dimensions satisfy constraints for valid execution; and producing a compiled configuration and a runtime-executable function from the companion module.
Clause 62. The method of Clause 61, wherein the compile-time assertions include at least one assertion that a value of a symbolic dimension is evenly divisible by a constant used in a division operation within the companion module.
Clause 63. A method for performing credit scaling in a compiler for a reconfigurable processor, the method comprising: compiling a computation graph having one or more symbolic dimensions, the computation graph including a metapipeline with a symbolic iteration count; computing a credit scaling value by dividing a counter value by the symbolic iteration count; and inserting the credit scaling computation into a companion module as a symbolic expression, wherein the credit scaling value is a configuration parameter settable at runtime.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method for compiling a computation graph for execution on a reconfigurable processor comprising one or more configurable compute units, the method comprising:
compiling the computation graph having one or more symbolic dimensions, the one or more symbolic dimensions having values unresolved at compile time, the compiling comprising tracking symbolic expressions as functions of the one or more symbolic dimensions; and
producing a compiled configuration for the reconfigurable processor, the compiled configuration comprising one or more configuration parameters derived from the tracked symbolic expressions, the one or more configuration parameters being settable at runtime based on runtime values of the one or more symbolic dimensions.

2. The method of claim 1, further comprising generating, from the tracked symbolic expressions, a runtime-executable function configured to compute derived values for the one or more configuration parameters from the runtime values of the one or more symbolic dimensions.

3. The method of claim 2, wherein the runtime-executable function is a host function executable on a host processor coupled to the reconfigurable processor.

4. The method of claim 1, wherein the tracking comprises constructing a companion module in a compiler intermediate representation, the companion module being separate from a main computation module representing the computation graph.

5. The method of claim 4, wherein a first stage and a second stage of a compilation pipeline insert respective symbolic expressions into the companion module.

6. The method of claim 1, wherein the one or more symbolic dimensions are annotated with minimum values, maximum values, and divisibility factors.

7. The method of claim 6, further comprising propagating the minimum values, the maximum values, and the divisibility factors through arithmetic operations on the symbolic expressions to derive corresponding annotations for the tracked symbolic expressions.

8. The method of claim 1, wherein the tracking comprises, responsive to creation of a new symbolic expression, canonicalizing the new symbolic expression at creation time to produce a canonicalized form.

9. The method of claim 8, further comprising determining equivalence of two symbolic expressions by identity comparison of their respective canonicalized forms.

10. The method of claim 1, further comprising resolving a symbolic inequality query during the compiling by performing a bound analysis using value range annotations of the one or more symbolic dimensions, and responsive to the bound analysis being insufficient to resolve the query, invoking a constraint solver.

11. The method of claim 10, further comprising caching a result returned by the constraint solver for reuse in a subsequent matching query.

12. The method of claim 1, wherein the compiled configuration encodes a tiled execution of the computation graph, the one or more configuration parameters comprising iteration counts for one or more tiled execution loops, and wherein compute operations within the tiled execution loops operate on data having static dimensions.

13. The method of claim 12, wherein the one or more symbolic dimensions are tiled to respective static tile sizes, a respective static tile size dividing the possible runtime values of the corresponding symbolic dimension.

14. The method of claim 1, wherein the one or more configuration parameters comprise at least one of a counter maximum value, a counter stride value, or a datapath immediate value of a configurable compute unit.

15. The method of claim 1, wherein producing the compiled configuration comprises allocating memory of the reconfigurable processor based on maximum values of the one or more symbolic dimensions.

16. The method of claim 4, wherein the companion module comprises a first operation type capturing user-defined symbolic dimensions with associated annotations and a second operation type capturing compiler-derived symbolic values referenced by the compiled configuration.

17. A method for executing a computation graph on a reconfigurable processor comprising one or more configurable compute units, the method comprising:
loading a compiled configuration onto the reconfigurable processor, the compiled configuration comprising one or more configuration parameters derived from symbolic expressions that are functions of one or more symbolic dimensions of the computation graph;
computing, from runtime values of the one or more symbolic dimensions and based on the symbolic expressions, derived values for the one or more configuration parameters;
setting the one or more configuration parameters of the reconfigurable processor to the derived values; and
executing the computation graph on the reconfigurable processor.

18. The method of claim 17, wherein the computing comprises executing a runtime-executable function generated during compilation of the computation graph from the symbolic expressions.

19. The method of claim 17, wherein the loading, computing, setting, and executing are repeated with different runtime values for the one or more symbolic dimensions using the same compiled configuration.

20. A non-transitory computer-readable medium storing a compiled configuration for a reconfigurable processor comprising one or more configurable compute units, the compiled configuration comprising:
configuration data for the one or more configurable compute units; and
one or more configuration parameters associated with respective symbolic expressions, the respective symbolic expressions representing functions of one or more symbolic dimensions of a computation graph from which the compiled configuration was produced, the one or more configuration parameters being settable at runtime based on runtime values of the one or more symbolic dimensions.
